(19) United States
(12) Patent Application Publication
(10) Pub. No.: US 2004/0017357 A1
(43) Pub. Date: Jan. 29, 2004

(54) Pointing device

(76) Inventors: Masahiro Kinoshita, Kyoto-shi (JP); Satoshi Nozoe, Kyoto-shi (JP); Hideyuki Bingo, Kyoto-shi (JP); Sho Sasaki, Kyoto-shi (JP)

Correspondence Address: Jonathan P Osha, Rosenthal & Osha, Suite 2800, 1221 McKinney, Houston, TX, 77010, US

(21) Appl. No.: 10/362,984

(22) PCT Filed: Aug. 13, 2001
(86) PCT No.: PCT/JP01/06999

(30) Foreign Application Priority Data
Aug. 29, 2000 (JP) 2000-259267
Sep. 22, 2000 (JP) 2000-288923

(51) Int. Cl. G09G 5/08

(52) U.S. Cl. 345/163

(57) ABSTRACT

A circuit substrate 8 mounting a flow sensor 6 thereto is stored into a concave portion 7 formed on the lower face of a mouse case 2. When a mouse 1 is moved, a flow of the air is relatively caused by inertia of the air, etc. The movement of the mouse 1 is detected by detecting the flow velocity of this air by the flow sensor 6.

### BACKGROUND OF INVENTION

1. Technical Field

The present invention relates to a pointing device provided as a peripheral device of a computer, etc., and using a novel principle.

2. Background Art

In a personal computer particularly used in a GUI environment, a pointing device of a mouse type (hereinafter called a mouse) is used to move a pointer on the display screen and operate a button and an icon on the screen and select various kinds of objects. A ball type has been used as such a mouse for a long time, but the mouse of an optical type is recently spread.

In the ball type mouse, the ball is held on the bottom face of a mouse case so as to be rolled. The ball is constructed by performing the surface processing of rubber on the surface of a steel ball, and is partially exposed from the bottom face of the mouse case. Therefore, when the mouse is placed on an operating face such as a desk, a mouse pad, etc. and the gripped mouse is manually moved, the ball is rolled on the operating face and is rotated by an angle according to the moving distance of the mouse. Two rotary encoders of a mechanical type or an optical type for detecting the number of rotations of the ball are arranged within the mouse. Rotation angles around two perpendicular axes of the ball are detected by these rotary encoders so that the moving distances of the mouse on the front and rear sides and the leftward and rightward sides are detected.

In the mouse of the optical type, light is irradiated to the operating face from a light emitting source such as a light emitting diode, etc. arranged within the mouse, and is formed as an image on the operating face. While the light reflected on the operating face is received by a light receiving element, a change in a light receiving pattern is read so that the displacing amount and/or the moving speed of the mouse is detected.

In the ball type mouse, power consumption is relatively small in comparison with the optical type mouse. However, in the ball type mouse, the ball is rotated by friction of the ball and the operating face. Therefore, operability of the mouse is greatly changed in accordance with the surface state of the operating face. Therefore, a problem exists in that the ball particularly runs idle on a smooth operating face and operability is greatly reduced. Further, in the ball type mouse, the number of parts is large and this mouse is heavy in weight and its assembly process is complicated.

Since no optical type mouse has a movable portion in a moving amount detecting portion, the necessity of maintenance is reduced in comparison with the ball type mouse. However, since the illumination light source must be lighted at any time in the optical type mouse, there is a disadvantage in that power consumption is increased. The optical type mouse has no influence even when the operating face such as a desk, a mouse pad, etc. is smooth. However, a problem exists in that no optical type mouse is easily operated when the operating face is a glass face and a uniform face having no pattern. Further, the number of parts is reduced in comparison with the ball type mouse, but is still large.

Further, the ball type mouse and the optical type mouse are operated by moving these mice on the operating face in principle. Accordingly, no mouse could be operated by moving the mouse in the air. There is a mouse of a track ball type as the mouse able to be operated in the air. However, in this mouse of the track ball type, the track ball is operated in the air, but no pointer on the screen of the personal computer can be moved even when the mouse itself is moved.

### DISCLOSURE OF THE INVENTION

An object of the present invention is to provide a pointing device such as a mouse, etc. constructed by a novel principle using a flow sensor. Further, another object of the present invention is to provide a pointing device such as a mouse, etc. utilizing a flow sensor and able to be operated in the air.

The present invention resides in a pointing device for outputting a signal showing a movement at an operating time, and characterized in that the pointing device comprises a flow sensor for detecting the velocity and/or acceleration of a gas flow; and means for outputting the signal showing the movement at the operating time on the basis of the relative movement of the gas detected by said flow sensor. Here, the movement at the operating time is shown by the moving direction, the moving speed and/or the moving acceleration, etc. when the pointing device is operated by a hand, etc.

In this pointing device, the moving speed and/or the moving acceleration of the pointing device can be detected by detecting the movement of the gas when the device is moved. Further, in accordance with such a pointing device, since there is no movable portion, the pointing device can be also used on a smooth operating face with good operability. The pointing device can be also used on the smooth operating face having no pattern as in the optical type mouse. Further, the number of parts can be reduced by using the flow sensor, and the pointing device can be made compact and reduced in cost. Further, electric power consumption can be reduced in comparison with the optical type mouse.

Further, in accordance with the pointing device using the flow sensor, the signal showing the movement can be also outputted in the operating case in the air without being limited to the operating case on a plane such as a desk, a pad, etc. Accordingly, it is also possible to manufacture the pointing device able to be operated in the air.

In an embodiment mode of the present invention, an opening opposed to the flow sensor is formed on the bottom face of a case for storing said flow sensor, and an elastic body is attached to the bottom face of the case so as to surround this opening. In accordance with such a structure, it is possible to prevent rubbish and dust from being invaded from the opening and attached to the flow sensor. Further, reliability of the pointing device is improved since there is no case in which a disturbance such as a wind, etc. is invaded from the opening and is detected by the flow sensor.

In another embodiment mode of the present invention, an opening opposed to the flow sensor is formed on the bottom face of a case for storing said flow sensor, and a shield object is arranged between this opening and the flow sensor, and a vent path is arranged in the shield object in a position dislocated from the flow sensor. Accordingly, it is possible to prevent that foreign matters such as rubbish, dust, etc. are invaded into the interior and are attached to the flow sensor, and a finger comes in contact with the flow sensor and sebum is attached to the flow sensor.

In still another embodiment mode of the present invention, an opening opposed to the flow sensor is formed on the bottom face of a case for storing said flow sensor, and a commutator for rectifying the direction of the gas flowed to the flow sensor position is arranged between this opening and the flow sensor. Accordingly, sensitivity of the flow sensor can be improved by arranging the commutator in consideration of a detecting direction for detecting the moving direction by the flow sensor.

In still another embodiment mode of the present invention, the pointing device further comprises means for detecting that the bottom face is floated. Accordingly, when the pointing device is raised from the operating face in use, the pointing device can be set such that no signal is outputted from the pointing device by detecting this raising and is recognized in error as the normal signal showing the movement.

In still another embodiment mode of the present invention, the pointing device can be also realized by stopping the flow of the gas within an area for locating the flow sensor when the bottom face of said case is floated.

In accordance with still another embodiment mode of the present invention, said flow sensor is arranged on the inner face of a closing case, and the gas passage between the inner face of the closing case opposed to the flow sensor and the flow sensor is narrowed in comparison with the others. In accordance with this embodiment mode, since the flow sensor is closed, the flow sensor can be held in a clean state in which dust, etc. are not attached to the flow sensor. Further, since the gas passage between the inner face of the closing case opposed to the flow sensor and the flow sensor is narrowed in comparison with the others, the gas is flowed at large acceleration in the flow sensor at the moving time of the pointing device so that sensitivity of the mouse can be improved.

In accordance with still another embodiment mode of the present invention, said flow sensor is arranged on the inner face of a closing case, and gases of two kinds or more having different specific gravities are sealed within the closing case. In accordance with this embodiment mode, since the flow sensor is closed, the flow sensor can be held in a clean state in which dust, etc. are not attached to the flow sensor. Further, since the closing type is used, there is no fear that the pointing device is operated in error even when the pointing device is raised from the operating face or is used in the air. Further, the sensitivity of the mouse can be improved since the gases of two kinds or more having different specific gravities are sealed within the closing case.

In accordance with still another embodiment mode of the present invention, the pointing device further comprises means for removing the influence of gravitational acceleration. Accordingly, it is possible to prevent that the gas warmed by the flow sensor is naturally convected by the gravitational acceleration and is detected by the flow sensor and becomes an output. Accordingly, accuracy of the pointing device can be raised. There is a high-pass filter arranged at a stage after the flow sensor as the means for removing the influence of the gravitational acceleration. Since the natural convection caused by the gravitational acceleration has a constant acceleration, a signal due to the influence of the gravitational acceleration can be removed by passing the high-pass filter even when the natural convection is detected by the flow sensor and the signal is outputted.

A structure for holding the flow sensor in the same posture with respect to a gravitational direction may be also used as the means for removing the influence of the gravitational acceleration. There are a suspending system, a balancing toy system, an autogyro, etc. as the means for holding the flow sensor in the same posture with respect to the gravitation. The natural convection is caused by the gravitational acceleration when the flow sensor is inclined. Accordingly, if the flow sensor is set so as to be held in the same posture even when the pointing device is inclined, no output of the pointing device is easily influenced by the gravitational acceleration.

In the pointing device in which the flow sensor is exposed to the atmosphere, the main outputted signal is a speed signal at the moving time so that the influence of the gravitational acceleration can be canceled by the acceleration detected by an acceleration sensor.

In accordance with still another embodiment mode of the present invention, the pointing device may have an operating portion able to output an output signal, or set so as not to output the output signal. When the pointing device is operated in the air, there is a case in which it is desirous to return the pointing device to a position near a hand without outputting the moving signal of the pointing device, e.g., when the hand is completely extended, etc. In such a case, the pointing device is moved by setting the output signal so as not to be outputted by operating an operating portion constructed by a push button switch, etc. Thus, for example, only the pointing device can be moved without moving a pointer on the screen of a personal computer.

In accordance with still another embodiment mode of the present invention, the signal showing the movement in three-dimensional directions can be outputted. Since the pointing device of the present invention can be operated in the air, the three-dimensional movement can be detected and outputted by the flow sensor so that the pointing device can be used as a pointing device for the three dimensions.

The present invention also resides in another pointing device for outputting a signal showing an inclination at an operating time, and characterized in that the pointing device comprises a flow sensor for detecting the velocity and/or acceleration of a gas flow; and means for outputting the signal showing the inclination at the operating time on the basis of the relative movement of the gas detected by said flow sensor. Here, the inclination at the operating time includes an inclining direction and an inclining speed.

In this pointing device, the inclination of the pointing device can be detected by detecting the movement of the gas at the moving time of the device. Accordingly, a signal according to the inclination can be outputted by inclining and rotating the pointing device in the air. Furthermore, in accordance with such a pointing device, the number of parts can be reduced by using the flow sensor.

The constructional elements of this invention explained above can be arbitrarily combined with each other as much as possible.

### BRIEF DESCRIPTION OF THE DRAWINGS

FIG. 1 is an exploded perspective view seen from the upper face side of a mouse in accordance with one embodiment mode of the present invention.

FIG. 2 is an exploded perspective view seen from the lower face side of the mouse shown in FIG. 1.

FIG. 3(a) is a view in which the section of the mouse shown in FIG. 1 is partially omitted. FIG. 3(b) is an enlarged view of an A-portion of FIG. 3(a).

FIG. 4 is a plan view of a flow sensor used in the mouse shown in FIG. 1.

FIG. 5 is a sectional view of the flow sensor shown in FIG. 4.

FIG. 6 is a view for explaining the measuring principle of the flow velocity of a gas using the flow sensor shown in FIG. 4.

FIG. 7 is a view showing a moving direction of the mouse.

FIG. 8 is a schematic sectional view for explaining a situation in which the flow of the gas is caused within a sensor storing chamber when the mouse is moved.

FIG. 9 is a schematic view showing the principle for generating a signal showing the movement of the mouse.

FIG. 10 is a circuit diagram for embodying the signal generating principle of the mouse shown in FIG. 9.

FIGS. 11(a) and 11(b) are views showing a reference voltage V₀ of a reference voltage output circuit and a reference frequency F₀ of a V/F converting circuit in a signal processing circuit of FIG. 10.

FIG. 12(a) is a view showing the displacement of the mouse in its +X direction. FIG. 12(b) is a view showing the relative flow velocity of the gas at that time. FIG. 12(c) is a view showing an X-axis flow sensor output. FIG. 12(d) is a view showing the output of the V/F converting circuit.

FIG. 13(a) is a view showing the displacement of the mouse in its −X direction. FIG. 13(b) is a view showing the relative flow velocity of the gas at that time. FIG. 13(c) is a view showing the X-axis flow sensor output. FIG. 13(d) is a view showing the output of the V/F converting circuit.

FIG. 14(a) is a view showing the outputs of an up/down counter and the gate of an exclusive logical sum when the mouse is moved in the +X direction. FIG. 14(b) is a view showing the outputs of the up/down counter and the gate of the exclusive logical sum when the mouse is moved in the −X direction.

FIG. 15 is a view showing the displacement of the mouse outputted from the mouse and restored by an encoder.

FIG. 16 is a waveform chart of a signal outputted from the flow sensor when the mouse is raised from an operating face.

FIG. 17 is an exploded perspective view seen from the upper face side of a mouse in accordance with another embodiment mode of the present invention.

FIG. 18 is an exploded perspective view seen from the lower face side of the mouse shown in FIG. 17.

FIG. 19 is an exploded perspective view showing the structure of a sensor case shown in FIGS. 17 and 18 and seen slantingly from above.

FIG. 20 is an exploded perspective view seen from the lower face side of the above sensor case.

FIGS. 21(a) and 21(b) are enlarged sectional views for explaining the operation of the above sensor case.

FIGS. 22(a) and 22(b) are enlarged sectional views for explaining the structure and the operation of a sensor case used in a mouse in accordance with still another embodiment mode of the present invention.

FIG. 23 is a sectional view showing a state in which a dust cover is attached to an opening of a mouse case in still another embodiment mode of the present invention.

FIG. 24 is a sectional view showing a state in which an elastic body is attached to the bottom face of a mouse case in still another embodiment mode of the present invention.

FIGS. 25(a) and 25(b) are a perspective view and a sectional view of a sensor storing portion having a flow sensor in still another embodiment mode of the present invention.

FIGS. 26(a) and 26(b) are a sectional view and a bottom view of a sensor storing chamber having a commutator therein in still another embodiment mode of the present invention.

FIGS. 27(a) and 27(b) are a sectional view and a bottom view of a sensor storing chamber having a commutator therein in still another embodiment mode of the present invention.

FIGS. 28(a) and 28(b) are a sectional view and a bottom view of a sensor storing chamber having a commutator therein in still another embodiment mode of the present invention.

FIG. 29 is a schematic sectional view of the mouse having a sensor for detecting the operating face in still another embodiment mode of the present invention.

FIG. 30 is a bottom view and a sectional view of a sensor storing chamber having a commutator therein in still another embodiment mode of the present invention.

FIG. 31 is a perspective view of the opening state of a cover member in the mouse of a closing type in still another embodiment mode of the present invention.

FIG. 32 is a sectional view showing a movement detecting unit of the closing type used in the mouse shown in FIG. 31.

FIG. 33 is a circuit diagram showing a signal processing circuit used in the closing type mouse shown in FIG. 31.

FIG. 34(a) is a view showing the displacement of the mouse in its +X direction. FIG. 34(b) is a view showing the acceleration of the gas at that time. FIG. 34(c) is a view showing the flow velocity of the gas. FIG. 34(d) is a view showing the restored displacement.

FIGS. 35(a) and 35(b) are sectional views showing the movement detecting unit of the closing type used in the mouse of the closing type in accordance with still another embodiment mode of the present invention.

FIG. 36 is a view for explaining the influence of a gravitational acceleration in the mouse.

FIG. 37 is a circuit diagram showing a signal processing circuit of a mouse in accordance with still another embodiment mode of the present invention.

FIG. 38 is a view showing the frequency characteristics of a high-pass filter used in the signal processing circuit shown in FIG. 37.

FIG. 39 is a perspective view showing a mouse in accordance with still another embodiment mode of the present invention and a movement detecting unit within this mouse.

FIG. 40 is a sectional view of the movement detecting unit shown in FIG. 39.

FIG. 41 is a perspective view of a mouse in accordance with still another embodiment mode of the present invention.

FIG. 42 is a perspective view showing the mouse of a three-dimensional type in accordance with still another embodiment mode of the present invention and a movement detecting unit within this mouse.

FIG. 43 is a circuit diagram of a signal processing circuit used in the mouse shown in FIG. 42.

FIG. 44 is a perspective view showing the mouse of a three-dimensional type in accordance with still another embodiment mode of the present invention.

FIG. 45 is a perspective view showing the structure of a movement detecting unit built-in the mouse of FIG. 44.

FIGS. 46(a), 46(b) and 46(c) are views for explaining the operating principle of a mouse in accordance with still another embodiment mode of the present invention.

FIG. 47 is a circuit diagram showing a signal processing circuit used in the mouse of FIG. 46.

FIGS. 48(a) and 48(b) are schematic views showing a flow sensor and an acceleration sensor of a mouse in accordance with still another embodiment mode of the present invention.

FIG. 49 is a circuit diagram showing a signal processing circuit used in the mouse of FIG. 48.

FIG. 50 is a schematic view showing an embodiment mode using a closing type flow sensor as the acceleration sensor.

FIG. 51 is a circuit diagram showing a signal processing circuit used in a mouse in accordance with still another embodiment mode of the present invention.

FIG. 52 is a perspective view showing a mouse in accordance with still another embodiment mode of the present invention.

FIG. 53 is a perspective view showing a mouse in accordance with still another embodiment mode of the present invention.

FIG. 54 is a perspective view showing a mouse in accordance with still another embodiment mode of the present invention.

FIG. 55 is a circuit diagram showing a signal processing circuit used in the mouse of FIG. 54.

FIG. 56(a) is a sectional view of a pointing device in accordance with still another embodiment mode of the present invention. FIG. 56(b) is a sectional view showing its using state.

FIG. 57(a) is a sectional view of a joystick in accordance with still another embodiment mode of the present invention. FIG. 57(b) is a sectional view showing its using state.

FIG. 58(a) is a perspective view of the pointing device of a pen type in still another embodiment mode of the present invention. FIG. 58(b) is an enlarged sectional view of a B-portion of FIG. 58(a).

FIG. 59 is a view showing the schematic construction of a pointing device in accordance with still another embodiment mode of the present invention.

FIG. 60 is a perspective view showing a head mount display having a pointing device using a flow sensor in still another embodiment mode of the present invention.

FIG. 61 is a perspective view showing the pointing device of a wristwatch type in accordance with still another embodiment mode of the present invention.

FIG. 62(a) is a partially broken perspective view showing a track ball arranged in a personal computer in still another embodiment mode of the present invention. FIG. 62(b) is an enlarged sectional view showing one portion of this track ball.

FIG. 63(a) is a partially broken perspective view showing a pointing device arranged in a personal computer in still another embodiment mode of the present invention. FIG. 63(b) is an enlarged sectional view showing one portion of this pointing device.

### BEST MODE FOR CARRYING OUT THE INVENTION

The preferred embodiment modes of the present invention will next be explained in detail with reference to the drawings.

In the pointing device of the present invention, various modes such as a mouse type, a pen type, a handle type, etc. can be used, but the mouse type will first be explained in the following embodiment modes.

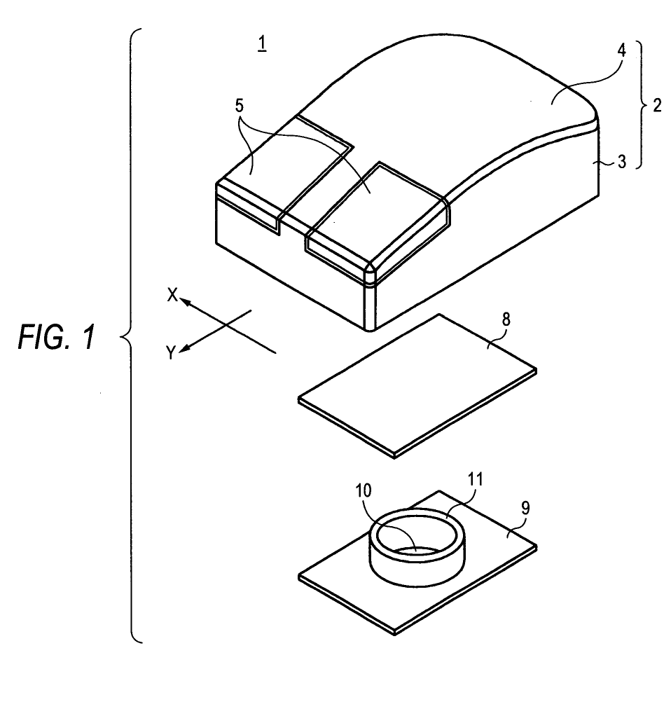

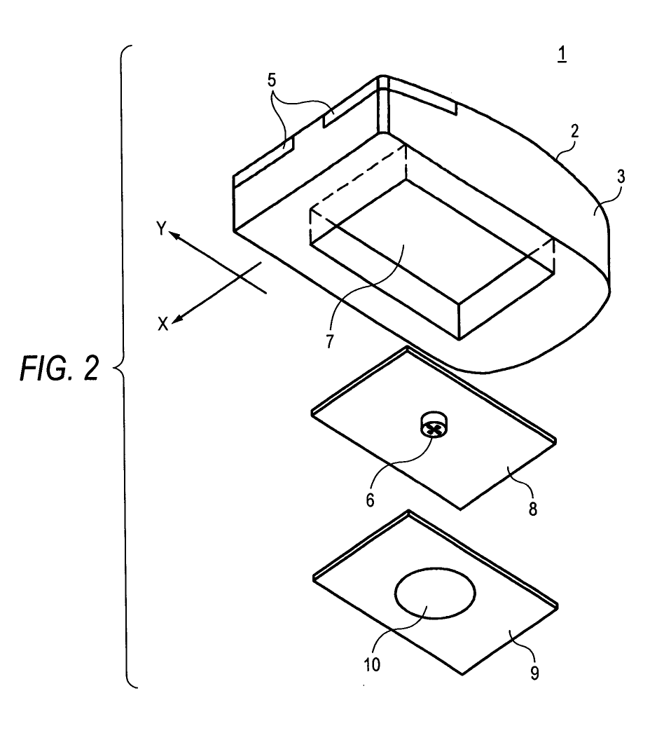

(First embodiment mode) FIG. 1 and 2 show the structure of a mouse 1 (mouse type pointing device) in accordance with one embodiment mode of the present invention, and are an exploded perspective view seen from the upper face side and an exploded perspective view seen from the lower face side. A mouse case 2 is constructed by a case main body 3 opened on its upper face and a case cover 4 attached so as to block the upper face opening of the case main body 3. Two click buttons 5 are arranged in the front portion of the case cover 4. An unillustrated signal processing circuit for generating a signal by operating each click button 5 is stored into the mouse case 2. In the illustrated example, the two click buttons 5 are arranged in the front portion of the mouse case 2, but three or more click buttons may be also arranged, and a wheel may be also arranged.

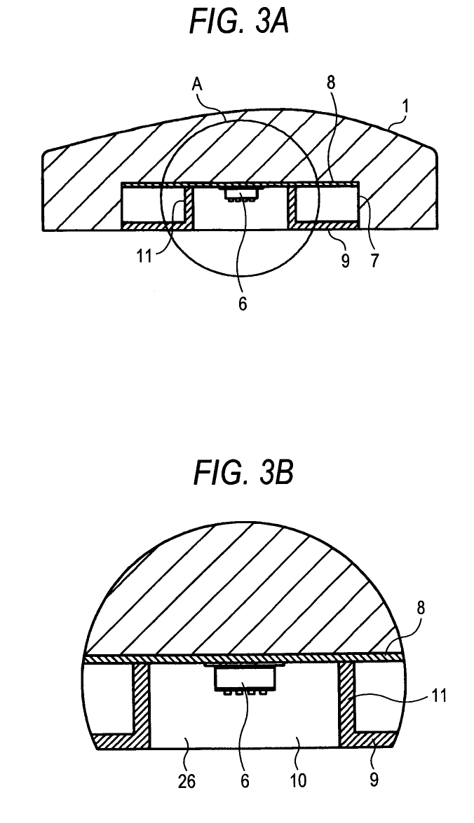

A concave portion 7 for storing a flow sensor 6 is arranged on the bottom face of the mouse case 2. The flow sensor 6 is stored into the concave portion 7 of the mouse case 2 in a state in which the flow sensor 6 is mounted to the lower face of a circuit substrate 8. After the flow sensor 6 is stored in the concave portion 7, a cover member 9 is attached to a lower face opening of the concave portion 7. An opening 10 is formed in the cover member 9 in the position opposed to the flow sensor 6. A sleeve portion 11 is vertically arranged on the upper face of the cover member 9 so as to surround the edge of the opening 10. The upper end of the sleeve portion 11 is closely attached to the lower face of the circuit substrate 8. As schematically shown in FIGS. 3(a) and 3(b), the flow sensor 6 is stored into a sensor storing chamber 26 having an upper face and an outer circumferential portion surrounded by the circuit substrate 8 and the sleeve portion 11, and is seen on the deep side of the opening 10 of the cover member 9. In the following explanation, the leftward and rightward directions of the mouse 1 are set to the X-axis direction, and the forward and backward directions of the mouse 1 are set to the Y-axis direction.

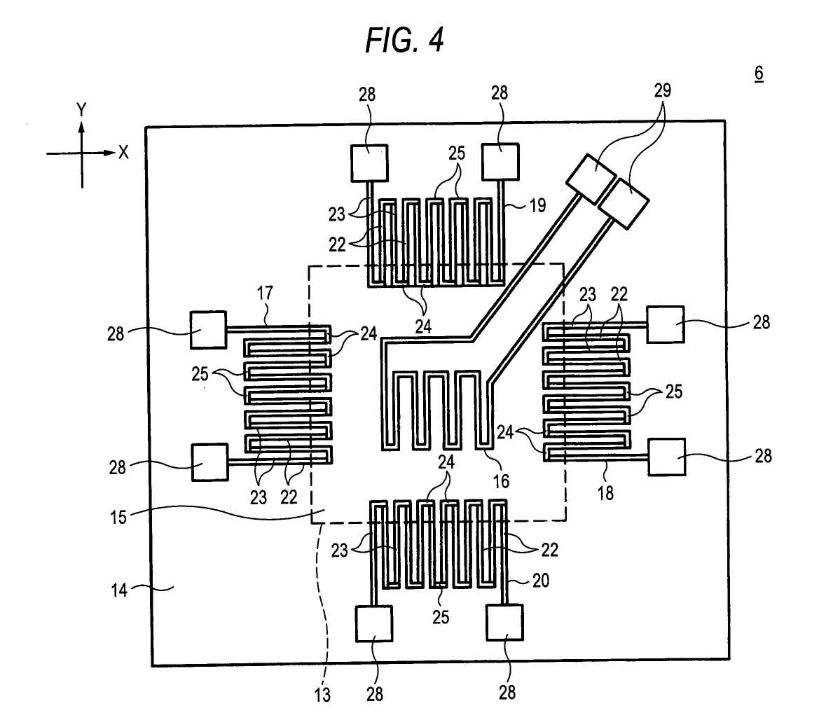

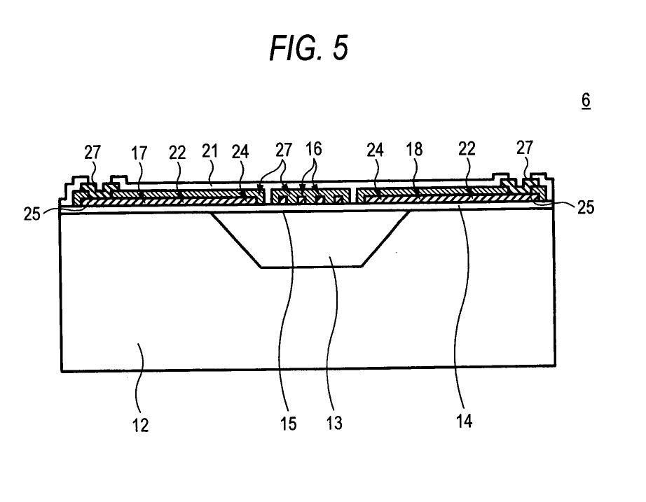

FIGS. 4 and 5 are a plan view and a sectional view showing the structure of the above flow sensor 6. A heater, a thermopile, etc. are shown in an exposed state in FIG. 4, and are also shown in a state covered with a protecting film 21, etc. in FIG. 5. In this flow sensor 6, a concave gap portion 13 is formed on the upper face of a silicon substrate 12, and an insulating thin film 14 is arranged on the upper face of the silicon substrate 12 so as to cover this gap portion 13. A bridge portion 15 of a thin film shape is formed on the gap portion 13 by one portion of this insulating thin film 14. This bridge portion 15 is thermally insulated from the silicon substrate 12 by a space (air) within the gap portion 13. A heater 16 is arranged on the surface of the bridge portion 15 in its central portion, and thermopiles 17, 18, 19, 20 are respectively arranged as temperature measuring bodies in leftward, rightward, forward and backward symmetrical positions with the heater 16 between. Thermopiles 17, 18 among these thermopiles 17, 18, 19, 20 detect the flow of a gas in the ±X directions, and thermopiles 19, 20 detect the flow of the gas in the ±Y directions. The silicon substrate 12 is coated with an oxide film 27 and a protecting film 21 so as to cover the heater 16 and the thermopiles 17, 18, 19, 20. Reference numerals 28 and 29 respectively designate an electrode pad of each of the thermopiles 17, 18, 19, 20, and an electrode pad of the heater 16.

The above thermopiles 17, 18, 19, 20 are constructed by a thermocouple constructed by BiSb/Sb. A first thin wire 22 constructed by BiSb and a second thin wire 23 constructed by Sb are alternately wired so as to cross the edge of the bridge portion 15. A group of warm contacts 24 is constructed by connection points of the first thin wire 22 and the second thin wire 23 within the bridge portion 15. A group of cold contacts 25 is constructed by connection points of the first thin wire 22 and the second thin wire 23 outside the bridge portion 15.

The numbers of warm contacts 24 and cold contacts 25 of the thermopiles 17, 18, 19, 20 are respectively set to n. The temperature of the warm contact 24 is set to Th, and the temperature of the cold contact 25 is set to Tc. In this case, an output voltage (voltage between both ends) V of each of the thermopiles 17, 18, 19, 20 is shown by the following formula (1).

V=n·α(Th−Tc) (1)

Here, α is a Seebeck coefficient. Accordingly, when the temperature (=temperature of the silicon substrate 12) of the cold contact 25 is constant or already known, the temperature of the warm contact 24 can be precisely measured by measuring the output voltage (voltage between both ends) V of each of the thermopiles 17, 18, 19, 20.

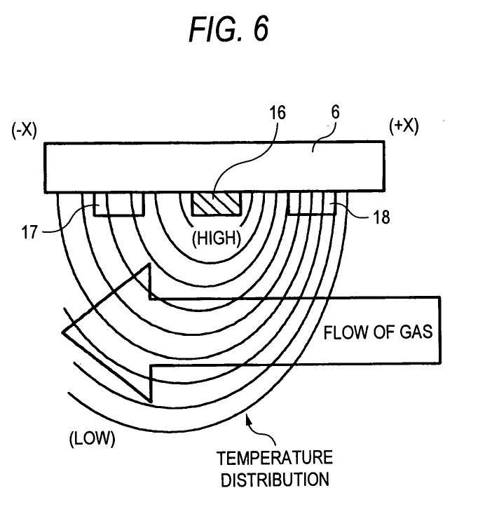

First, the operation of the flow sensor 6 will be explained. In this flow sensor 6, while heat is generated by flowing an electric current through the heater 16, the outputs of the leftward, rightward, forward and backward thermopiles 17, 18, 19, 20 are monitored, and the relative flow of a gas is detected. In a state (windless time) in which there is no flow of the gas in the X-axis direction, the warm contact temperatures of the thermopiles 17, 18 arranged on both sides in the X-axis direction through the heater 16 are equal to each other from the symmetry of the arrangement. Accordingly, the output voltages of the thermopiles 17 and 18 are equal to each other. In contrast to this, as shown by an arrow in FIG. 6, when the gas is moved from the +X direction to the −X direction, the warm contact of the thermopile 18 on the upstream side is cooled by the gas flow and is lowered in temperature, and its output voltage is reduced. In contrast to this, the heat of the heater 16 is transported to the downstream side by the gas, and the warm contact of the thermopile 17 on the downstream side is raised in temperature and its output voltage is increased. Further, the difference between the warm contact temperatures of both the thermopiles 17 and 18 is enlarged as the flowing speed of the gas is increased. Accordingly, the flow velocity of the gas can be measured by the difference between the output voltage values of both the thermopiles 17, 18 caused by this enlargement. The flow velocity of the gas can be similarly measured when the gas is flowed from the −X direction to the +X direction, and is flowed in the Y-axis direction.

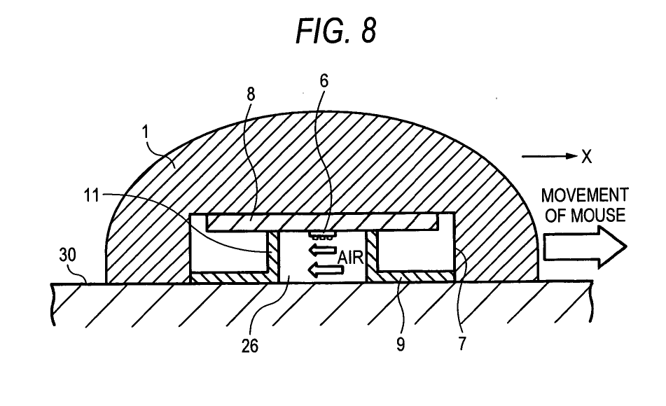

The principle for outputting the moving speed of the mouse 1 by using such a flow sensor 6 will next be explained. FIG. 8 shows a situation in which the mouse 1 is placed on an operating face 30 such as a desk, a mouse pad, etc. When the mouse 1 is placed on the flat operating face 30, the opening 10 on the lower face of the sensor storing chamber 26 is blocked by the operating face 30. It is not necessary to highly set the closing degree of the sensor storing chamber 26 at the placing time of the mouse 1 on the operating face 30 in comparison with the mouse of a closing type described later. However, it is necessary to set this closing degree to a close contact degree in which the flow sensor 6 sensitively senses an external wind of the mouse 1 and the movement of the air and is not operated in error.

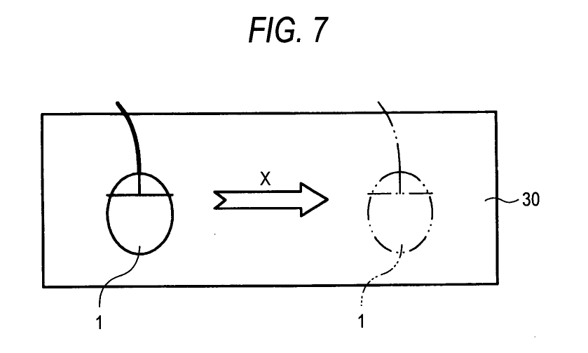

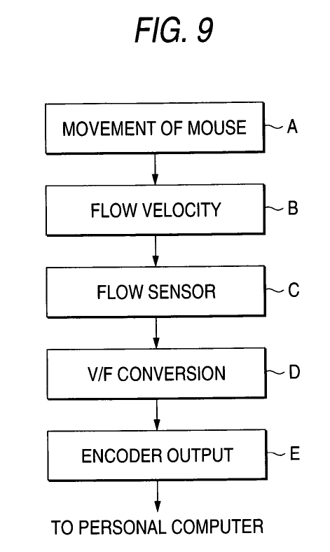

When the mouse 1 is moved in the +X direction as shown in FIG. 7 in a state placed such that the mouse 1 comes in close contact with the operating face 30 in this way, the air is relatively moved within the sensor storing chamber 26 in the −X direction with respect to the flow sensor 6 by friction of the air and the operating face 30 and inertia of the air as shown in FIG. 8. The explanation will be schematically made along FIG. 9. Thus, when an air flow (flow velocity) (B) is caused by the movement (A) of the mouse 1, its flow velocity is measured by the flow sensor 6(C), and is outputted as a voltage signal. Next, the voltage signal showing the flow velocity of the air is converted (D) to an alternating current signal of a frequency according to the flow velocity of the air by a voltage/frequency (V/F) converting circuit. Further, the alternating current signal is converted to an encoder output of a rectangular wave, and is outputted to a personal computer (E).

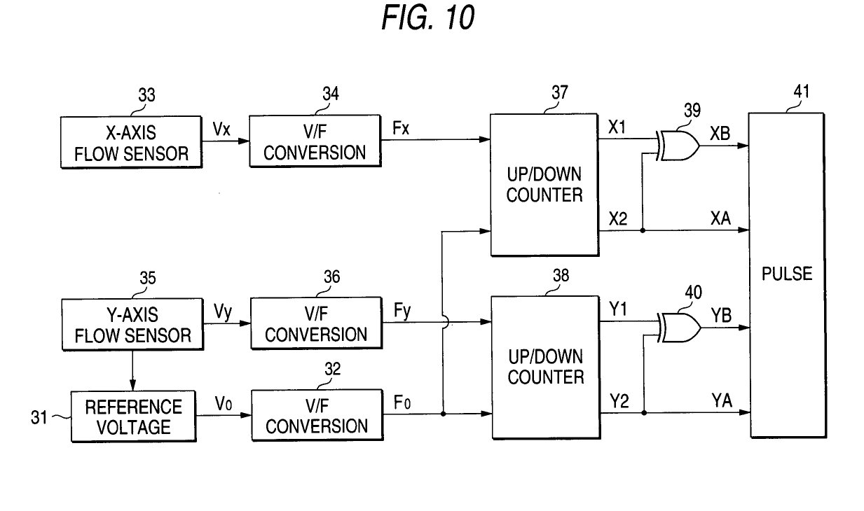

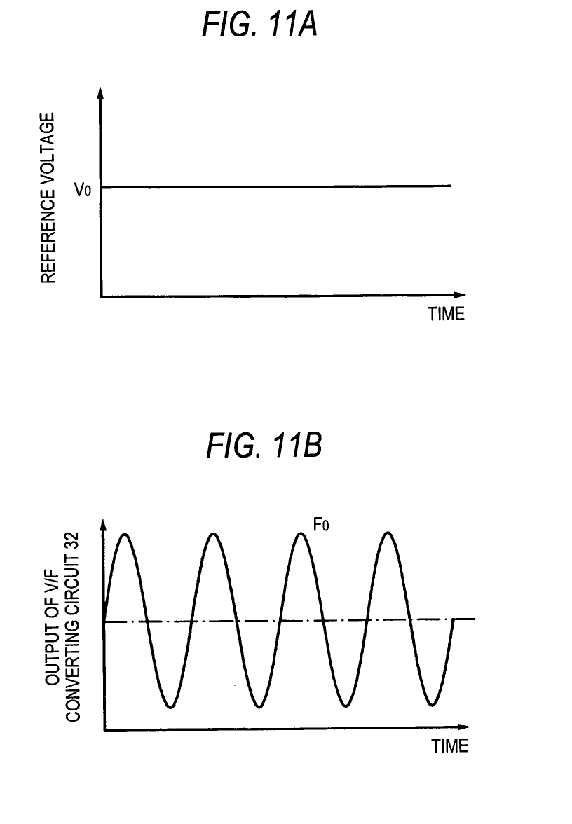

FIG. 10 is a circuit diagram showing a signal processing circuit for generating the encoder output showing the movement of the mouse 1. FIGS. 11, 12, 13, 14 and 15 are views showing its waveforms, etc. A constant voltage (reference voltage) V₀ as shown in FIG. 11(a) is outputted from a reference voltage output circuit 31. The reference voltage V₀ is outputted as a signal of a constant frequency (reference frequency) F₀ as shown in FIG. 11(b) by the V/F (voltage/frequency) converting circuit 32.

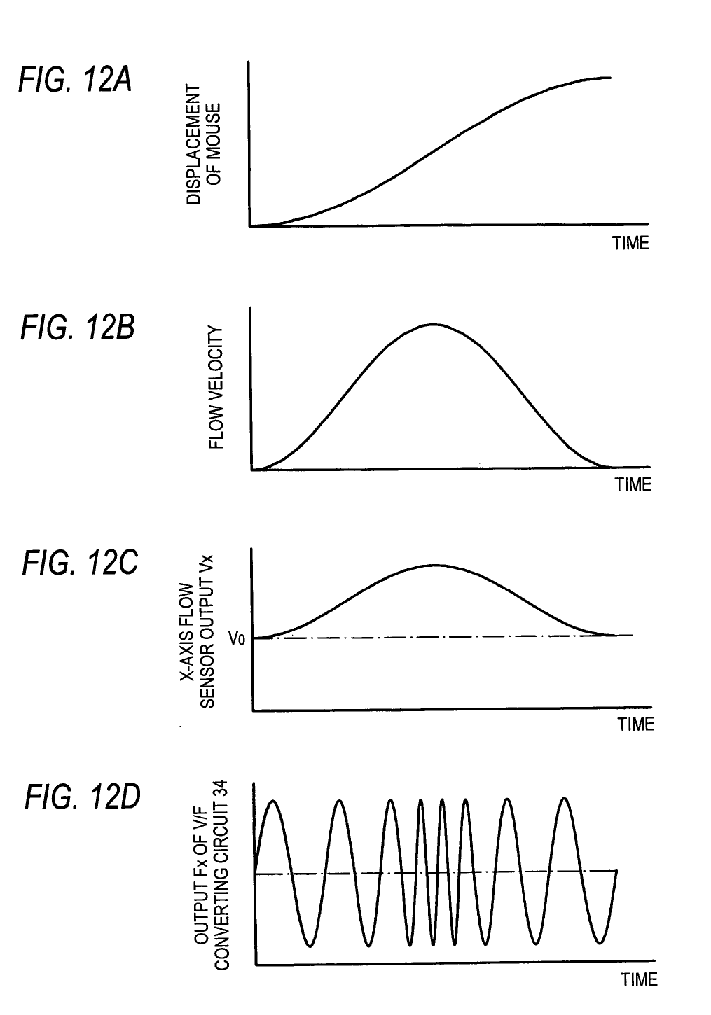

The output Vx of an X-axis flow sensor 33 in FIG. 10 shows the difference between the outputs of the thermopiles 17 and 18 arranged in the X-axis direction. For example, when the displacement of the mouse 1 at its moving time in the +X direction as shown in FIG. 7 is provided as shown in FIG. 12(a), the flow velocity of the air caused within the mouse 1 at that time is provided as shown in FIG. 12(b). A voltage signal Vx as shown in FIG. 12(c) corresponding to this flow velocity is outputted from the X-axis flow sensor 33. In this case, the X-axis flow sensor 33 has an offset voltage such that the output of the X-axis flow sensor 33 is the reference voltage V₀ at a time of 0 cm/sec in flow velocity. The output Vx of this X-axis flow sensor 33 is converted to a frequency signal by the V/F converting circuit 34, and is modulated to a signal of a high frequency as the output voltage is increased as shown in FIG. 12(d). Here, when the output Vx of the X-axis flow sensor 33 is V₀ (0 cm/sec in flow velocity), this output Vx is also modulated to a signal of the frequency F₀.

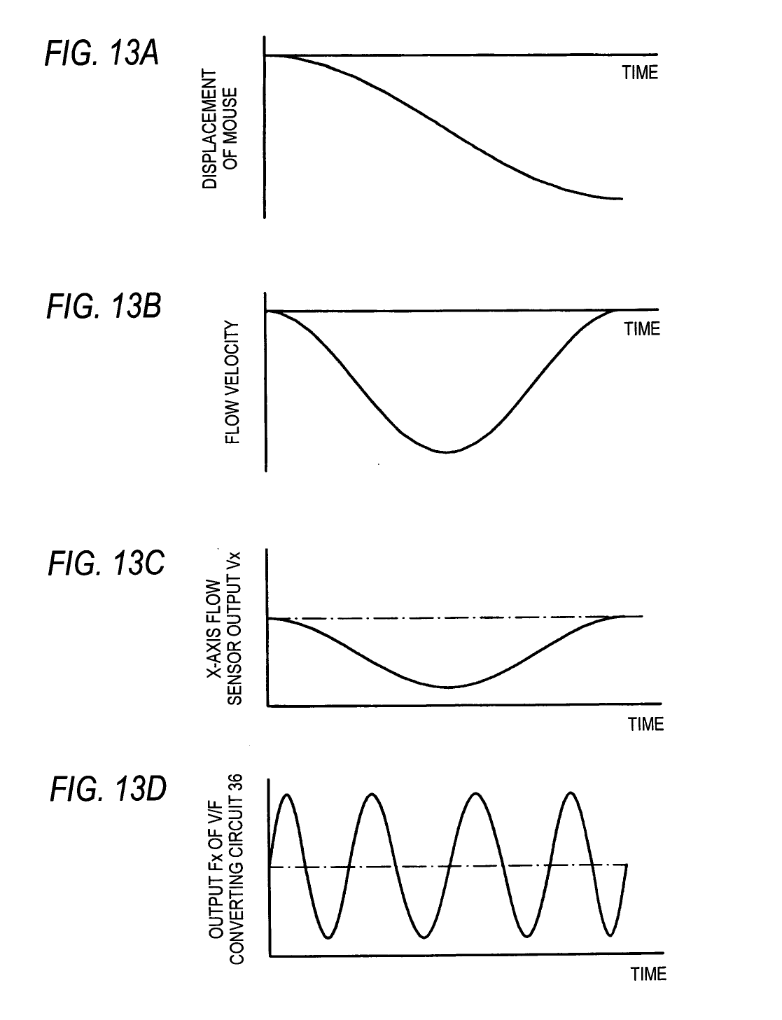

Conversely, when the displacement of the mouse 1 at the moving time in the −X direction is provided as shown in FIG. 13(a), the flow velocity of the air caused within the mouse 1 at that time is provided as shown in FIG. 13(b). A voltage signal Vx as shown in FIG. 13(c) corresponding to this flow velocity is outputted from the output Vx of the X-axis flow sensor 33. The output Vx of this X-axis flow sensor 33 is converted to a frequency signal by the V/F converting circuit 34, and is modulated to a signal of a low frequency as the output voltage is reduced as shown in FIG. 13(d).

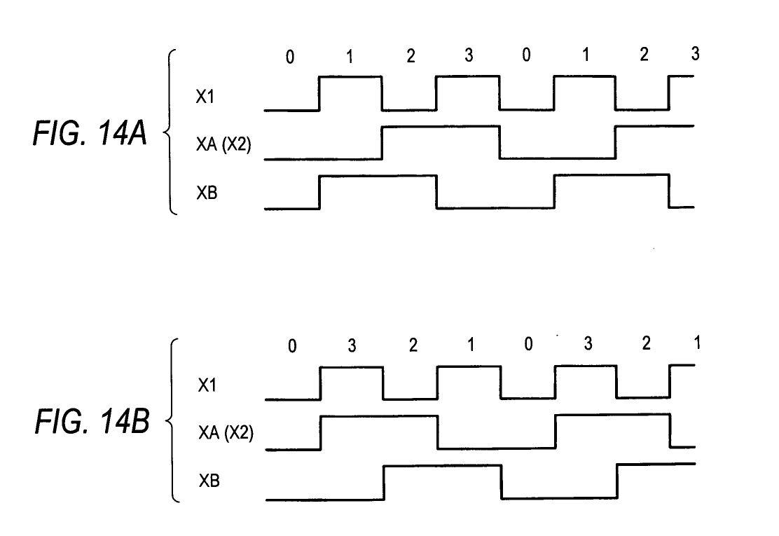

An up/down counter 37 is a binary counter which is increased by one every peak of the output signal Fx of the V/F converting circuit 34 on the X-axis flow sensor 33 side, and is decreased by one every peak of the output signal F₀ of the V/F converting circuit 32 on the reference voltage output circuit 31 side. An output X1 shows a first digit, and an output X2 shows a second digit. Namely, the up/down counter 37 is counted up every peak of the output signal Fx of the V/F converting circuit 34. As shown in FIG. 14(a), the outputs (X2, X1) of the up/down counter 37 are changed to (0,0), (0,1), (1,0), (1,1), (0,0), - - - . The up/down counter 37 is counted down every peak of the output signal F₀ of the V/F converting circuit 32. As shown in FIG. 14(b), the outputs (X2, X1) of the up/down counter 37 are changed to (0,0), (1,1), (1,0), (0,1), (0,0), - - - .

Accordingly, when the displacement of the mouse 1 in the X-axis direction is zero, the output frequency Fx of the V/F converting circuit 34 on the X-axis flow sensor 33 side and the output frequency F₀ of the V/F converting circuit 32 on the reference voltage output circuit 31 side are equal to each other. Accordingly, the counting-up operation and the counting-down operation oft he up/down counter 37 are balanced so that no output of the up/down counter 37 is changed. In contrast to this, the output frequency Fx of the V/F converting circuit 34 is increased as the moving speed of the mouse 1 in the +X direction is increased. Accordingly, the counting-up operation speed of the up/down counter 37 is increased in accordance with the moving speed in the +X direction. Further, the output frequency Fx of the V/F converting circuit 34 becomes smaller than the reference frequency F₀ as the moving speed of the mouse in the −X direction is increased. Accordingly, the counting-down operation speed of the up/down counter 37 is increased in accordance with the moving speed in the −X direction.

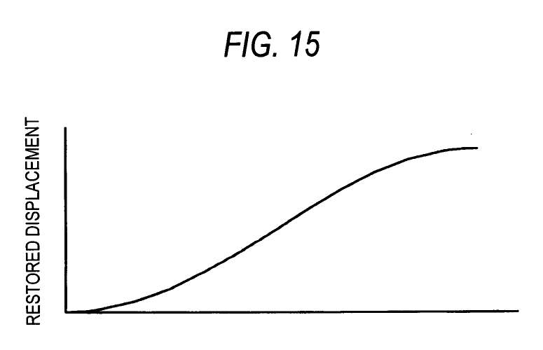

With respect to the outputs X1, X2 of the up/down counter 37, an exclusive logical sum is calculated by a gate 39 and is outputted as XB. The output X2 is outputted as XA as it is. XA and XB are outputted to the personal computer as encoder outputs (pulse signals) 41. These encoder outputs XA, XB are shown in FIGS. 14(a) and 14(b). As can be seen from these FIGS. 14(a) and 14(b), the moving direction of the mouse is discriminated from phase shifting directions of XA and XB, and the moving speed of the mouse is discriminated from changing speeds of the encoder outputs XA, XB. The displacement of the mouse is restored as shown in FIG. 15 by integrating the moving speed on the basis of the encoder outputs XA, XB on the personal computer side.

With respect to the Y-axis direction, encoder outputs YA, YB are outputted by a similar principle. Although the details are omitted, the difference in output between the thermopiles 19 and 20 arranged in the Y-axis direction is outputted from a Y-axis flow sensor 35, and this signal Vy is converted to a frequency signal Fy by a V/F converting circuit 36. Thereafter, this frequency signal Fy is inputted to an up/down counter 38 as a signal to count-up this up/down counter 38. The signal of the reference frequency F₀ outputted from the V/F converting circuit 32 on the reference voltage output circuit 31 side is also inputted to the up/down counter 38 so as to count-down the up/down counter 38. Outputs Y1, Y2 of the up/down counter 38 are converted to encoder outputs 41 (YA, YB) in the Y-direction by a gate 40 of the exclusive logical sum.

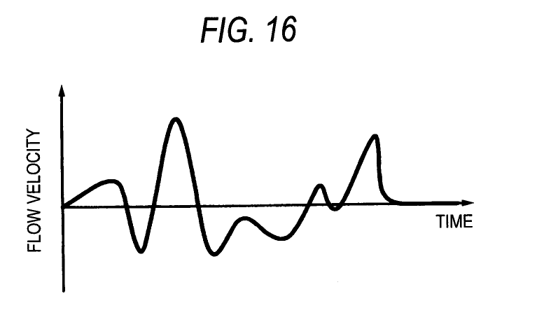

Next, a method for preventing an error in operation at a manual raising time of the mouse 1 from the operating face 30 will be explained. In the mouse 1 of the opening type explained here, the flow sensor 6 is exposed within the sensor storing chamber 26. Therefore, when the mouse 1 is raised from the operating face 30, there is a fear that the flow sensor 6 detects the flow velocity by a disturbance such as a wind, etc., and an error in operation is caused. However, the flow velocity detected by the flow sensor 6 at the operating time of the mouse 1 has a characteristic waveform as shown in FIGS. 12(b) and 13(b). In contrast to this, the waveform of the flow velocity detected at the raising time of the mouse 1 is an irregular waveform as shown in FIG. 16. Accordingly, when such an irregular waveform is outputted from the flow sensor 6, a signal from the signal processing circuit is masked so as not to output the encoder output from the mouse.

Otherwise, there is also an erroneous operation preventing measure in which a switch (a push button type, a pressure type, etc.) is arranged on the bottom face of the mouse, and is turned on when the mouse and the operating face come in contact with each other, and no output to the personal computer is performed when the switch is turned off.

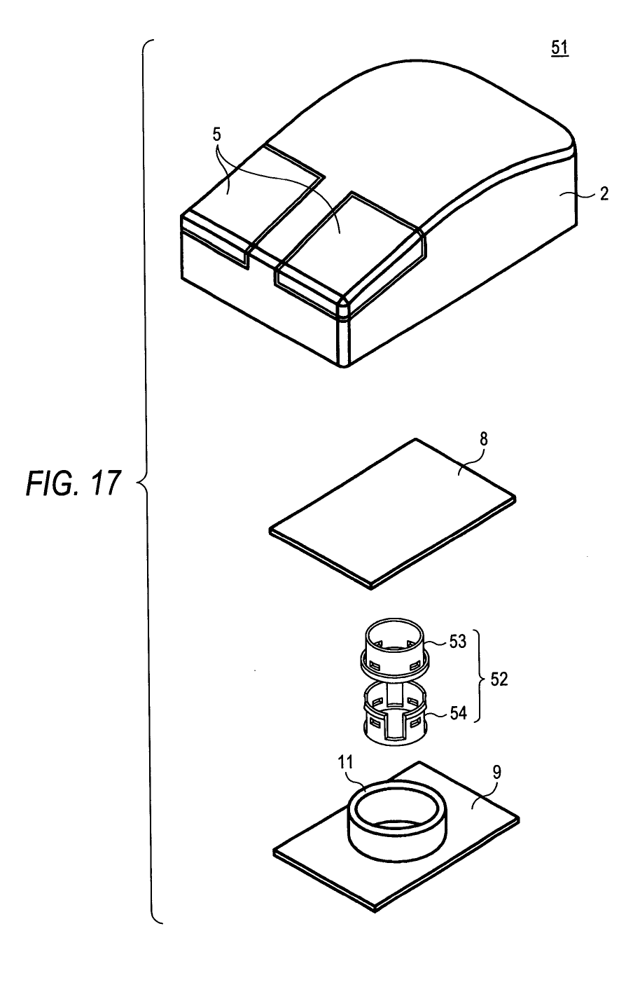

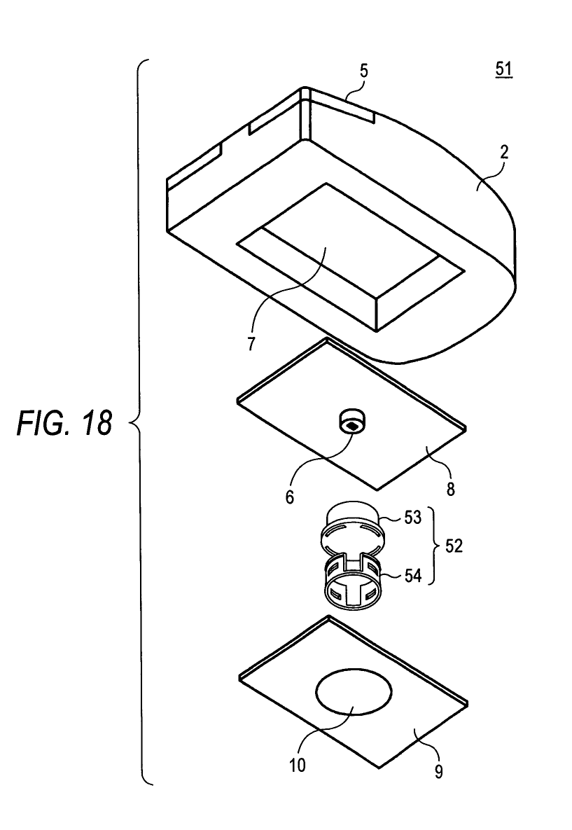

(Second embodiment mode) FIG. 17 is an exploded perspective view slantingly seen from above and showing the structure of a mouse in accordance with another embodiment mode of the present invention. FIG. 18 is an exploded perspective view slantingly seen from below. In this mouse 51, when the mouse 51 is raised from the operating face 30, the opening of the sensor storing chamber 26 is closed and the flow sensor 6 attains a non-detecting state. In contrast to this, when the mouse 1 is placed on the operating face 30, the opening of the sensor storing chamber 26 is opened and the flow sensor 6 attains a detecting state.

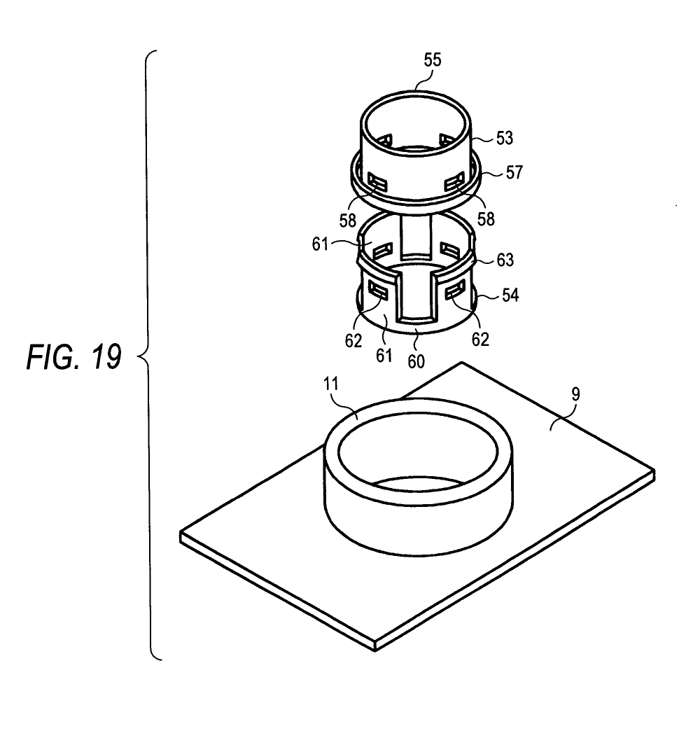

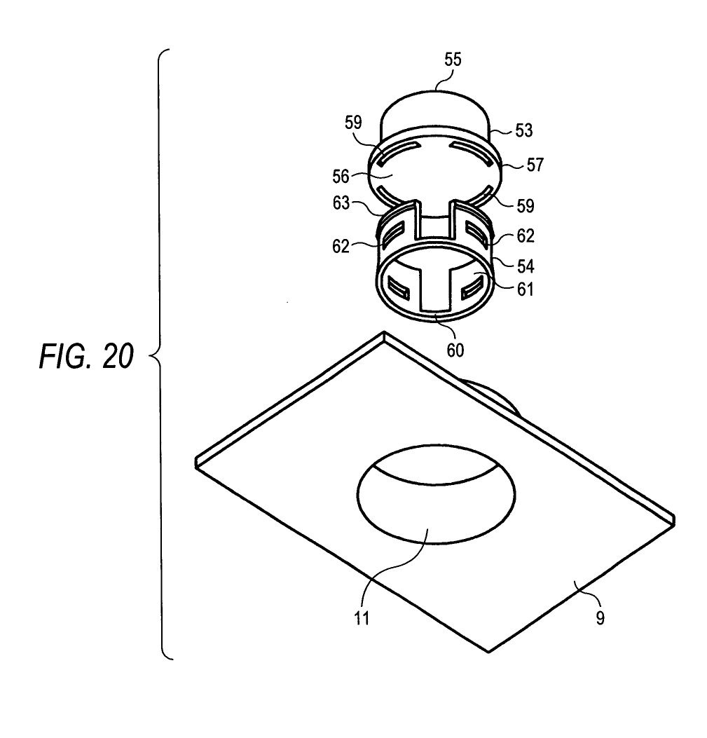

Therefore, in this embodiment mode, the flow sensor 6 is covered with a sensor case 52 constructed by a fixing portion 53 and a slider 54 as shown in FIGS. 19 and 20. The fixing portion 53 is constructed by a cylindrical sleeve body 55, a cover 56 on the lower face of the sleeve body 55, and a flange 57 around the cover 56. A vent hole 58 is opened in the sleeve body 55, and a hole 59 for the slider is opened in the flange 57. The slider 54 is formed by extending a sliding body 61 in the upward direction from an annular portion 60 vertically opened. A vent hole 62 is opened in the sliding body 61, and a claw 63 for preventing extraction is formed at the upper end of the sliding body 61. The sensor case 52 is assembled by slidably inserting the sliding body 61 of the slider 54 into the hole 59 for the slider in the fixing portion 53. The extraction of the sliding body 61 is prevented by engaging the claw 63 with the upper face of the flange 57.

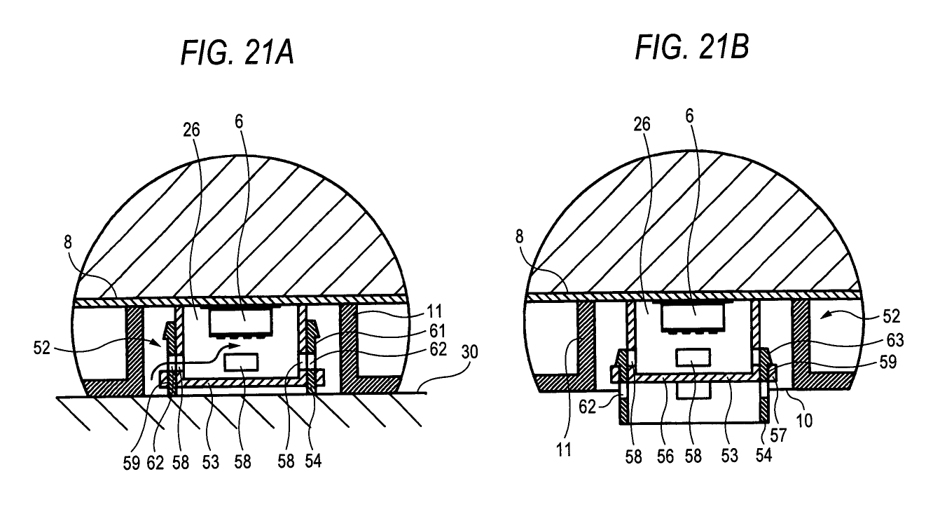

As shown in FIG. 21, the sensor case 52 is fixed by closely attaching the upper face of the fixing portion 53 to the lower face of the circuit substrate 8 so as to surround the flow sensor 6. The size of the sensor case 52 is smaller than the inside diameter of the sleeve portion 11. When no force for pushing-up the slider 54 is applied, the sensor case 52 is projected downward from the opening 10 at the lower end of the sleeve portion 11 as shown in FIG. 21(b). The claw 63 is stopped in an engaging state with the flange 57. Thus, in a state in which the slider 54 is lowered downward, the vent hole 58 of the fixing portion 53 i s blocked by the sliding body 61, and the sensor storing chamber 26 (a space within the sensor case 52) for storing the flow sensor 6 approximately attains a closing state. Accordingly, when the mouse 51 is raised from the operating face 30, the slider 54 is lowered and the vent hole 58 is blocked. Thus, it is possible to prevent an erroneous signal from being outputted by detecting the flow velocity such as a wind, etc. by the flow sensor 6.

On the other hand, in a state in which the mouse 51 is placed on the operating face 30, the slider 54 is pushed and retired by the operating face 30 so that the vent hole 58 of the fixing portion 53 and the vent hole 62 of the slider 54 are conformed to each other. When the mouse 51 is moved, the air is flowed from the vent holes 58, 62 into the sensor storing chamber 26, and the flow velocity is measured by the flow sensor 6, and encoder outputs showing the moving direction and the moving speed are outputted from the mouse 51.

Further, since the flow sensor 6 is covered with the sensor case 52, it is possible to prevent sensitivity from being deteriorated by the attachment of sebum, etc. when a finger, etc. come in contact with the flow sensor 6.

Further, when this embodiment mode is compared with the following third embodiment mode, no volume of the sensor storing chamber 26 is changed and no air within the sensor storing chamber 26 is compressed and expanded even when the slider 54 is vertically moved. Accordingly, no unnecessary flow of the gas is easily caused so that the sensitivity of the mouse 51 is stabilized.

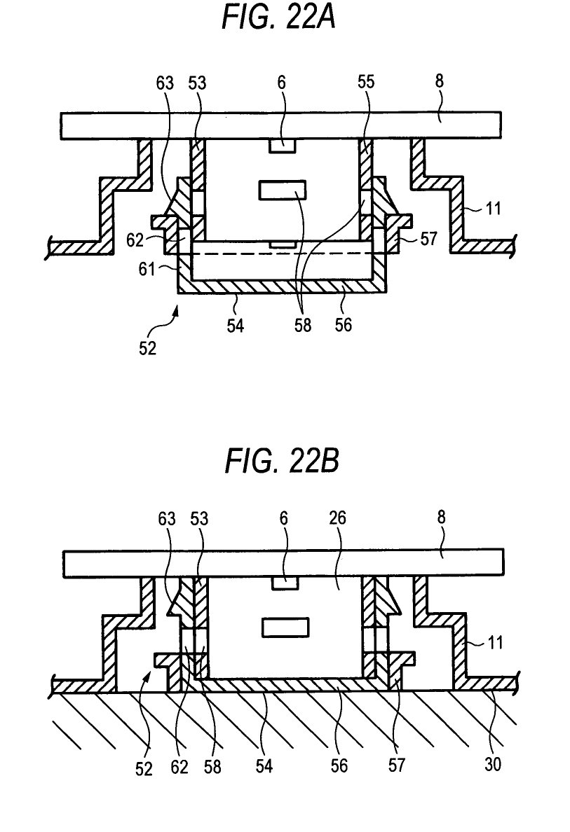

(Third embodiment mode) FIGS. 22(a) and 22(b) are sectional views showing the sensor case 52 of a mouse in accordance with still another embodiment mode of the present invention, and its vicinity structure. This mouse has a structure similar to that of the mouse 51 shown in FIGS. 17 to 21, but differs from the mouse 51 in that a cover 56 is arranged in the slider 54 instead of the fixing portion 53.

In this embodiment mode, when the mouse is raised from the operating face 30, the slider 54 is lowered as shown in FIG. 22(a), and the vent hole 58 of the fixing portion 53 is blocked by the sliding body 61. The vent hole 62 of the slider 54 is also blocked by the fixing portion 53 (flange 57), and the sensor storing chamber 26 within the sensor case 52 approximately attains a closing state. When the mouse is placed on the operating face 30, the slider 54 is pushed upward as shown in FIG. 22(b), and the vent hole 58 of the fixing portion 53 and the vent hole 62 of the slider 54 are conformed to each other. In contrast to this, when the mouse is moved, the air is flowed from the vent holes 58, 62 into the sensor storing chamber 26, and the flow velocity is measured by the flow sensor 6. Encoder outputs showing the moving direction and the moving speed are outputted from the mouse.

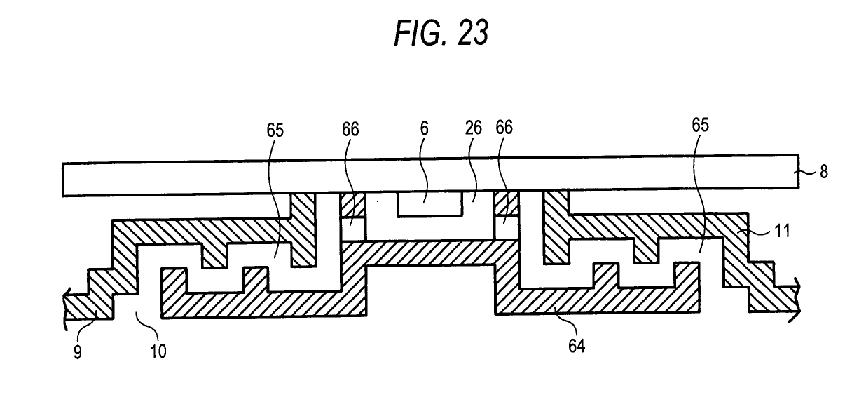

(Fourth embodiment mode) FIG. 23 is a sectional view showing one portion of a mouse in accordance with still another embodiment mode of the present invention. In this embodiment mode, a dust cover 64 is arranged in the opening 10 of the cover member 9, and a meandering air passage 65 is formed between the dust cover 64 and the sleeve portion 11. Further, the flow sensor 6 is stored into the sensor storing chamber 26 arranged in the upper portion of the dust cover 64, and a vent port 66 is opened on the wall face of the sensor storing chamber 26. In accordance with such a structure, it is prevented that rubbish, dust, etc. are attached to the flow sensor 6, and a finger, etc. come in contact with the flow sensor 6. Thus, operation reliability of the flow sensor 6 is improved.

A perforated film and a perforated plate, etc. having many opened round holes and slid holes can be also used as a dust cover except for this dust cover.

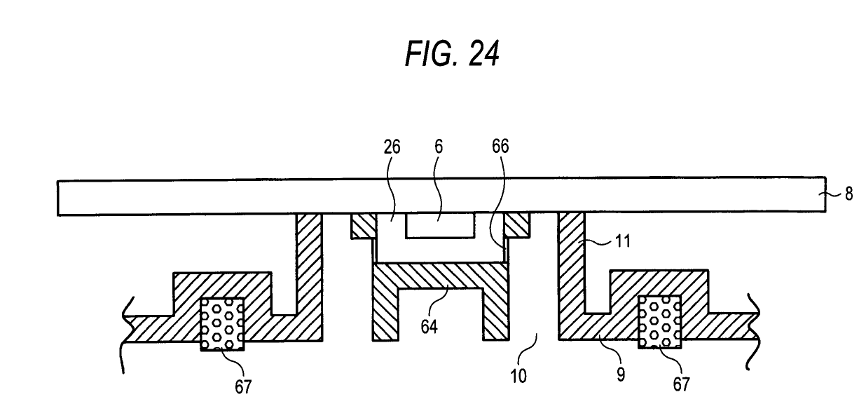

(Fifth embodiment mode) FIG. 24 is a sectional view showing one portion of a mouse in accordance with still another embodiment mode of the present invention. In this embodiment mode, an elastic body 67 such as a sponge, etc. easily deformed i s attached t o the bottom face o f the c over member 9 so a s to surround the circumference of the opening 10, and blocks the gap between the bottom face of the mouse and the operating face 30. Thus, the invasion of dust, etc. into the sensor storing chamber 26 is prevented, and operation reliability of the flow sensor 6 is improved. Further, the erroneous detection of the flow sensor 6 due to a disturbance such as a wind, etc. is prevented, and accuracy of the mouse is improved.

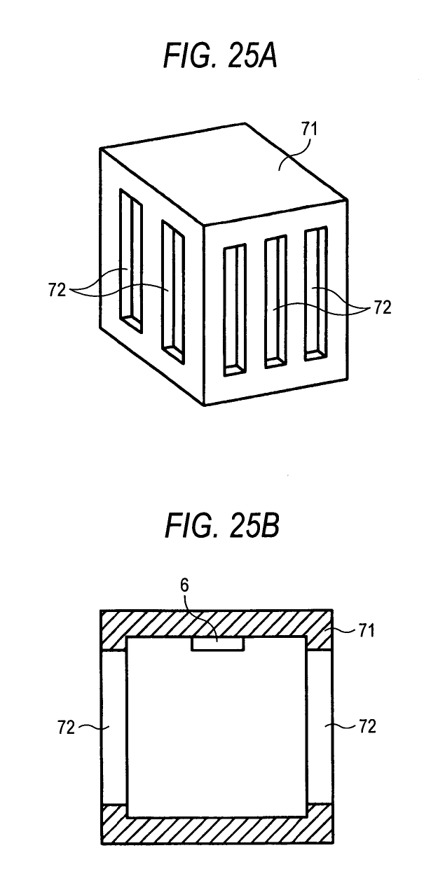

(Sixth embodiment mode) FIG. 25 is a perspective view showing one portion of a mouse in accordance with still another embodiment mode of the present invention. In this embodiment mode, the flow sensor 6 is attached to the lower face of a ceiling portion of a sensor storing portion 71 formed in a box shape. An air passage 72 formed in the shape of a longitudinal elongated hole is opened in side walls (four faces) of the sensor storing portion 71 in its air flowing-in direction (detecting direction). This sensor storing portion 71 is stored into a concave portion 7 on the lower face of the mouse case 2. In accordance with such a structure, sensitivity of the flow sensor 6 can be improved by smoothly flowing the air in the X-axis direction and the Y-axis direction.

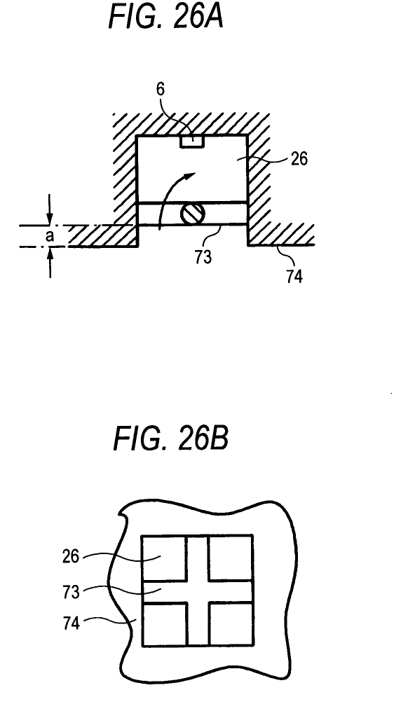

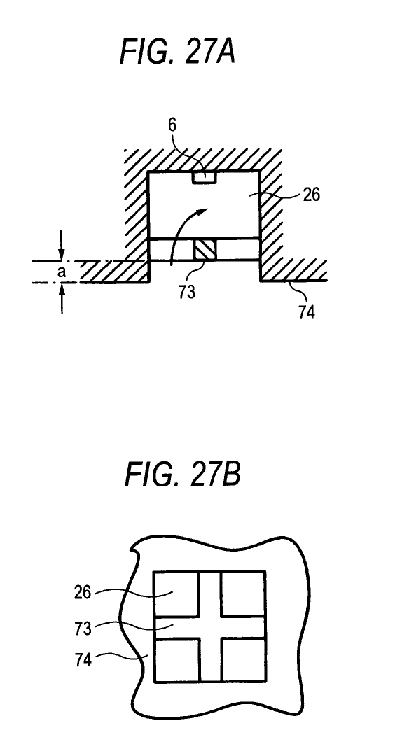

(Seventh embodiment mode) FIGS. 26(a) and 26(b) are a sectional view and a bottom view showing one portion of a mouse in accordance with still another embodiment mode of the present invention. FIGS. 27(a) and 27(b) are a sectional view and a bottom view showing a similar embodiment mode. In this embodiment mode, the flow sensor 6 is arranged on the ceiling face of the sensor storing chamber 26, and a commutator 73 formed in a cross shape seen from a plane is arranged in the sensor storing chamber 26. The commutator 73 is extended perpendicularly to the detecting direction (the X-axis direction and the Y-axis direction) of the mouse, and has a circular shape (in the case of FIG. 25) in section or a rectangular shape (in the case of FIG. 26) in section. The distance between the lower face of the commutator 73 and the bottom face 74 of the mouse is set to a suitable distance a. In accordance with such a structure, the invasion of rubbish and dust is interrupted by the commutator 73 so that it is possible to prevent the rubbish and the dust from being attached to the flow sensor 6. It is also possible to prevent sebum from being attached to the flow sensor 6 when a finger comes in contact with the flow sensor 6. Further, sensitivity of the flow sensor 6 can be improved since the air is smoothly flowed in the X-axis direction and the Y-axis direction at the moving time of the mouse.

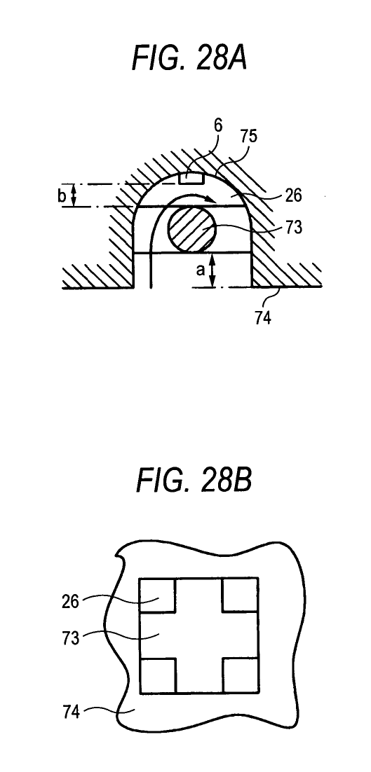

(Eighth embodiment mode) FIGS. 28(a) and 28(b) are a sectional view and a bottom view showing one portion of a mouse in accordance with still another embodiment mode of the present invention. In this embodiment mode, the ceiling face of the sensor storing chamber 26 is formed in a semispherical surface shape, and the flow sensor 6 is attached to this ceiling face 75. The commutator 73 formed in a cross shape seen from a plane is extended perpendicularly to the detecting direction (the X-axis direction and the Y-axis direction) of the mouse, and is arranged in the sensor storing chamber 26. Further, the distance a between the lower face of the commutator 73 and the bottom face 74 of the mouse is set to be greater than the distance b between the upper face of the commutator 73 and the flow sensor 6(b<a). In this embodiment mode, since the ceiling face 75 is formed i n t he semispherical shape, the air is more smoothly flowed so that the sensitivity of the flow sensor 6 is further improved.

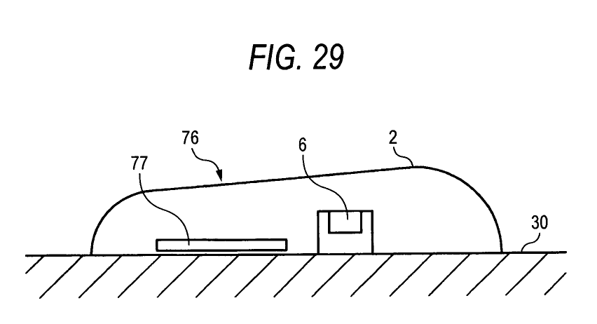

(Ninth embodiment mode) FIG. 29 is a schematic sectional view of a mouse 76 in accordance with still another embodiment mode of the present invention. In this embodiment mode, a sensor 77 for detecting the operating face 30 is arranged in the vicinity of the bottom face of the mouse case 2. A proximity switch for detecting the operating face 30 such as a steel desk, etc. manufactured by a metal, an electrostatic capacity type sensor for detecting the electrostatic capacity between a metallic electrode and the operating face, an optical sensor able to detect the operating face 30, etc. can be used as such a sensor 77. When it is judged that the mouse 76 is placed on the operating face 30, an encoder output is outputted from the mouse 76. In contrast to this, when it is judged that the mouse 76 is floated from the operating face, no encoder output is outputted from the mouse 76 so that no erroneous encoder output is outputted.

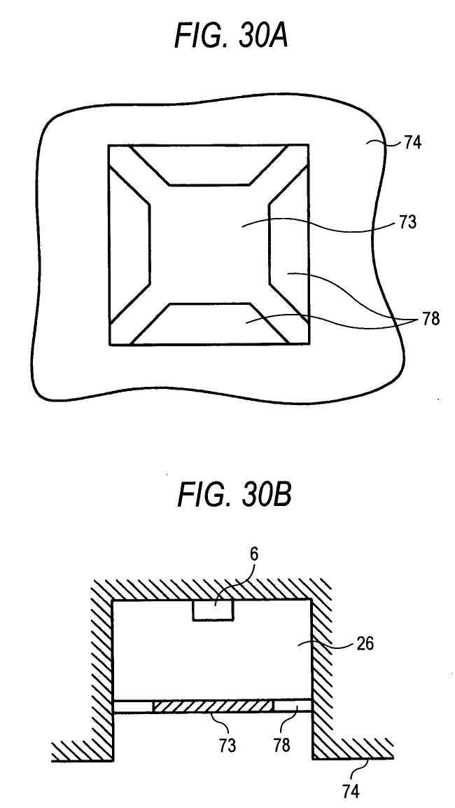

(Tenth embodiment mode) FIG. 30 is a sectional view and a bottom view showing one portion of a mouse in accordance with still another embodiment mode of the present invention. In this embodiment mode, a commutator 73 formed in a plate shape is attached in the position of the sensor storing chamber 26 slightly recessed from the mouse bottom face 74, and four openings 78 in total are arranged in the detecting direction (the X-axis direction and the Y-axis direction) of the flow sensor 6. In this embodiment mode, the air is also smoothly flowed by the commutator 73 in the X-axis direction and the Y-axis direction, and the sensitivity of the flow sensor 6 can be further improved. Further, it is possible to prevent rubbish and dust from being attached to the flow sensor 6 by covering the lower portion of the flow sensor 6 with the commutator 73.

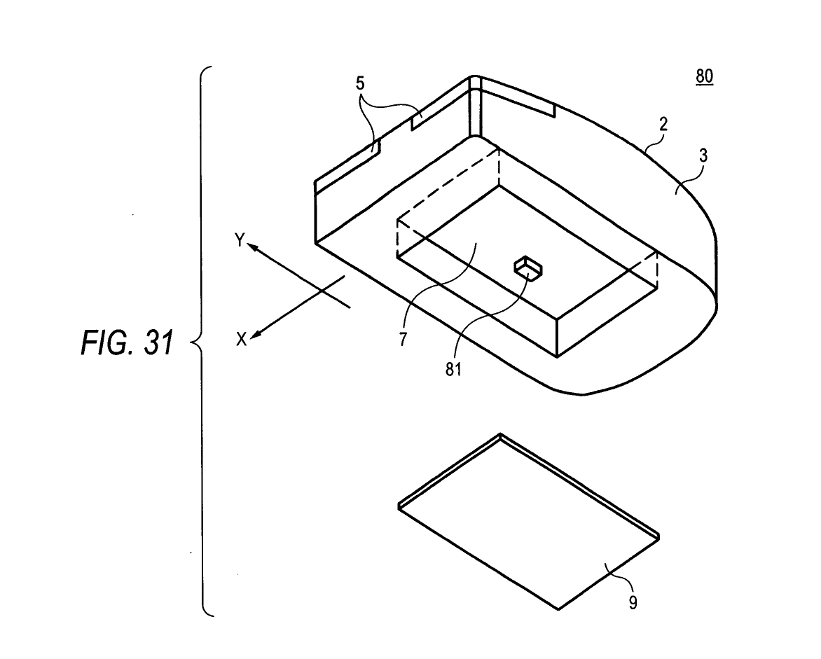

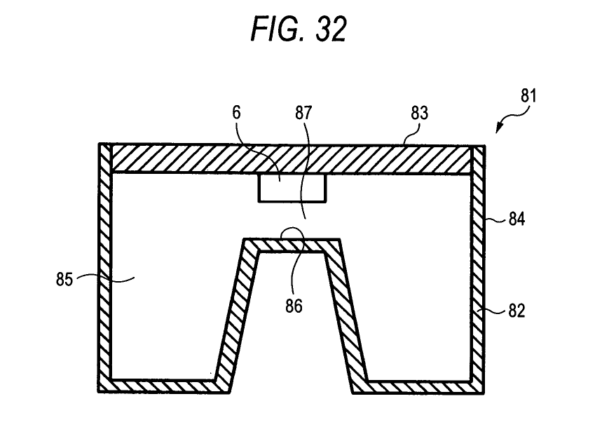

(Eleventh embodiment mode) FIG. 31 is a perspective view showing a mouse in accordance with still another embodiment mode of the present invention. A movement detecting unit 81 of a close type is attached into the concave portion 7 arranged on the bottom face of the mouse case 2, and the concave portion 7 is blocked by the cover member 9. FIG. 32 is a sectional view showing the structure of the movement detecting unit 81. This movement detecting unit 81 is stored into the mouse case 2. In this movement detecting unit 81 of the closing type, a circuit substrate 83 is attached to the upper face of a closing case 82, and the flow sensor 6 attached to the lower face of the circuit substrate 83 is sealed within the sensor storing chamber 26 constructed by the circuit substrate 83 and the closing case 84. Further, a gas 85 is sealed within the sensor storing chamber 26. Further, the distance between the flow sensor 6 and the bottom face of the closing case 84 is reduced in a portion opposed to the flow sensor 6 by upwardly expanding the portion 86 opposed to the flow sensor 6 among the bottom face of the closing case 82 so that a flow path 87 of the gas 85 is narrowed.

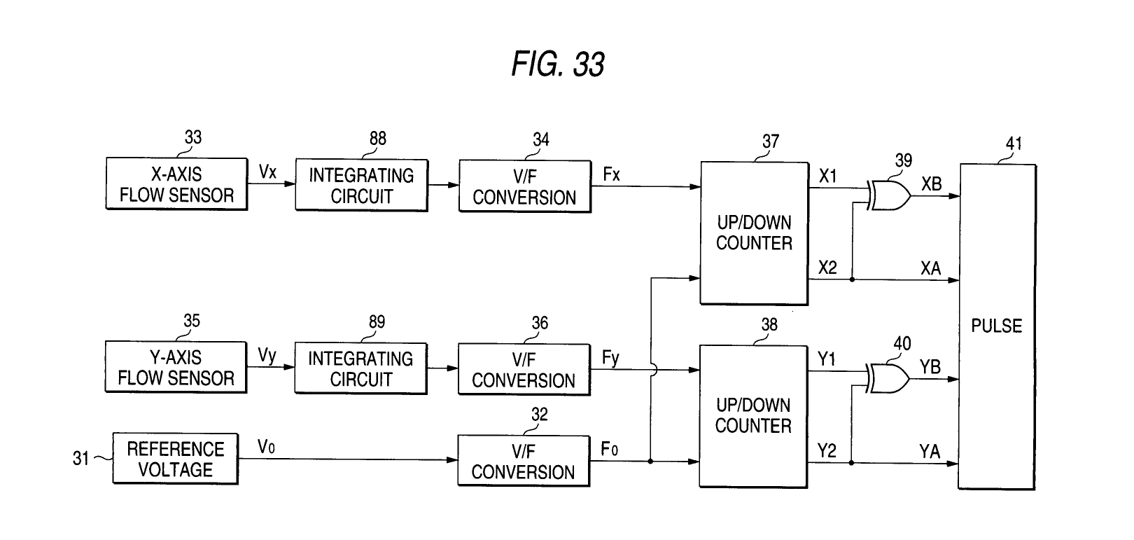

In such a mouse 80 (hereinafter called a closing type mouse in a certain case) having the movement detecting unit 81 of the closing type, an encoder output is outputted to the personal computer by using a signal processing circuit as shown in FIG. 33. As can be seen from comparison with the signal processing circuit of FIG. 10, the output (the difference between the outputs of the thermopiles 17, 18) from the X-axis flow sensor 33 is integrated by an integrating circuit 88 and is then outputted to the V/F converting circuit 34, and the output (the difference between the outputs of the thermopiles 19, 20) from the Y-axis flow sensor 35 is also integrated by an integrating circuit 89 and is then outputted to the V/F converting circuit 36 in this embodiment mode. The other constructions are the same as the construction of the signal processing circuit of FIG. 10.

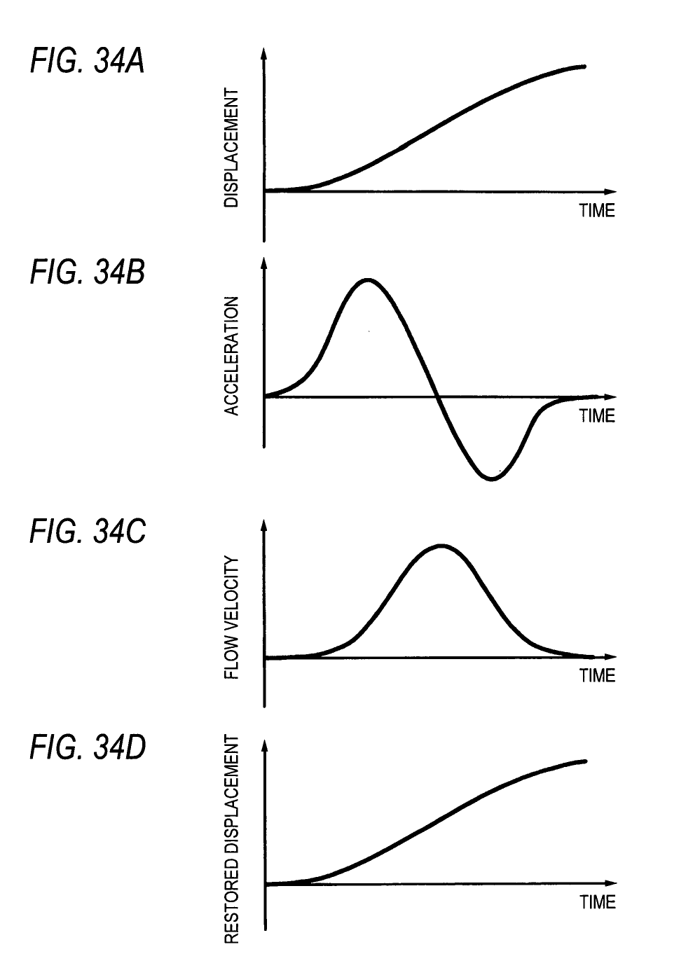

In the mouse 80 of the close type, as shown in FIG. 34(a), when the mouse is moved on the operating face 30 e.g., in the +X direction, the output from the X-axis flow sensor 33 becomes a signal showing acceleration of the displacement as shown in FIG. 34(b). Accordingly, the acceleration signal outputted from this X-axis flow sensor 33 is converted (actually has a reference voltage V₀ as an offset value) to a speed signal as shown in FIG. 34(c) by integrating this acceleration signal by the integrating circuit 88. Thereafter, similar to the signal processing circuit of FIG. 10, an encoder output showing the moving direction and the moving speed is outputted. In the personal computer, the displacement of the mouse is restored on the basis of this encoder output as shown in FIG. 34(d).

Such a closing type mouse has no influence of a disturbance such as a wind, etc. when the mouse is raised. However, this closing type mouse is low in sensitivity in comparison with the mouse of the opening type. Therefore, in this embodiment mode, as described above, the gas flow path 87 is narrowed under the flow sensor 6 so as to increase the flow velocity of the gas 85 in the position of the flow sensor 6 so that the sensitivity of the mouse is improved.

Further, since such a closing type mouse has no influence of a disturbance such as a wind, etc. even when the mouse is raised in the air, the mouse can be moved and operated on the operating face such as a desk, a mouse pad, etc., and can be also moved and operated in the air.

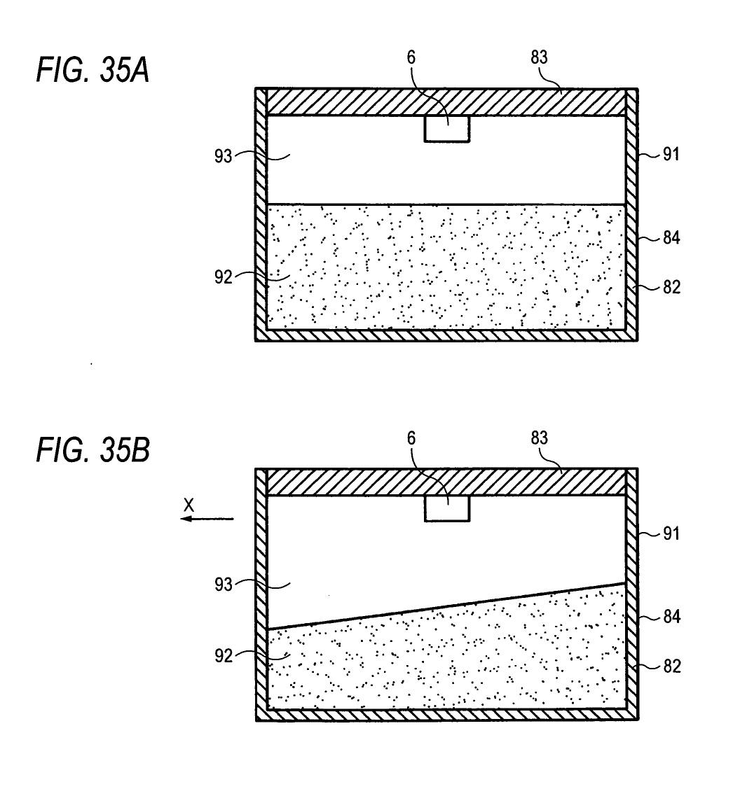

(Twelfth embodiment mode) FIGS. 35(a) and 35(b) shows a movement detecting unit 91 used in the closing type mouse in still another embodiment mode of the present invention. In this movement detecting unit 91, two kinds of gases constructed by a gas 92 relatively heavy in specific gravity and a gas 93 relatively light in specific gravity are sealed within the sensor storing chamber 26 constructed by the circuit substrate 83 and the closing case 82. As shown in FIG. 35(a), the heavy gas 92 and the light gas 93 are separated into two layers within the sensor storing chamber 2 6. In this state, as shown in FIG. 35(b), when the mouse is moved in the +X direction, the heavy gas 92 is relatively moved in the −X direction by inertia, etc. so that the light gas 93 is pushed out in the +X direction. At this time, the flow (acceleration) of the light gas is detected by the flow sensor 6. In this embodiment mode, the flow of the light gas 93 is structurally amplified by sealing the heavy gas 92 and the light gas 93 so that the sensitivity of the mouse is raised.

Next, the relation of the mouse using the flow sensor 6 and the acceleration will be explained. In the opening type mouse and the closing type mouse, the output signal from the flow sensor 6 at the moving time of the mouse using the flow sensor 6 includes a signal component according to the speed of the mouse in the moving direction at its operating time, a signal component according to the acceleration in the moving direction, and a signal component provided by the gravitational acceleration.

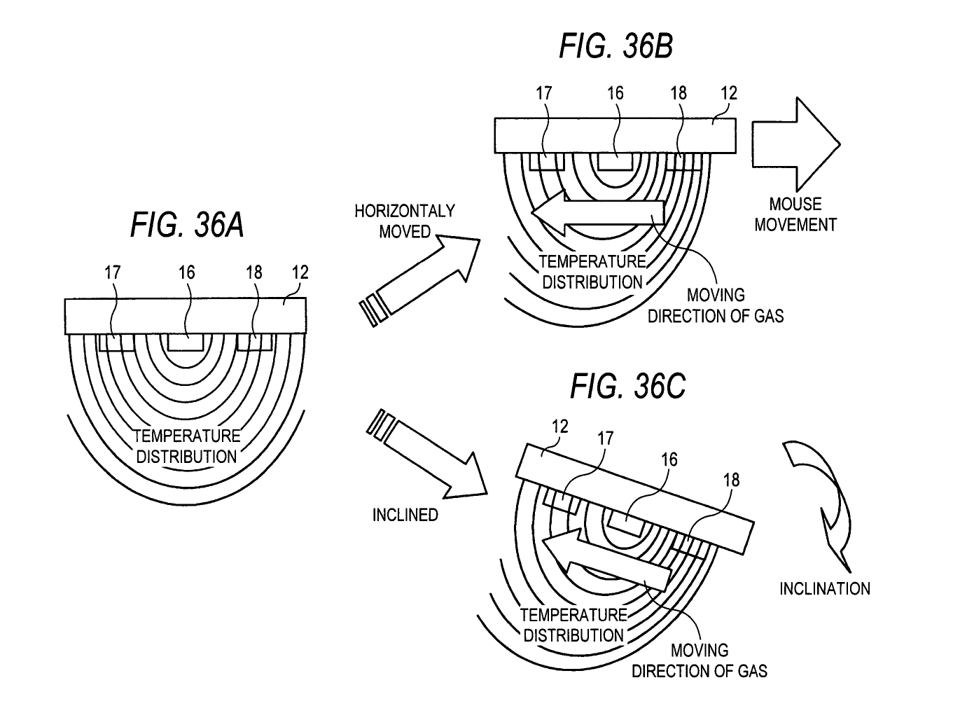

This signal component provided by the gravitational acceleration is generated by arranging the heater 16 in the flow sensor 6. For example, in the case of the X-axis direction, as shown in FIG. 36(a), the flow sensor 6 has a structure in which the thermopiles 17, 18 are arranged on both sides of the heater 16. When the mouse mounting the flow sensor 6 thereto is horizontally moved, as shown in FIG. 36(b), a difference signal of the thermopiles 17, 18 is changed since temperature distributions on the thermopile 17 side and the thermopile 18 side are different from each other (see the explanation of FIG. 6). However, since the gas is warmed by the heater 16 in such a flow sensor 6, the warmed gas is raised as shown in FIG. 36(c) when the mouse (i.e., the flow sensor 6) is inclined. Thus, a temperature distribution similar to that in FIG. 36(b) is formed by a convection current. Therefore, when the mouse is not moved but is inclined, the difference signal is outputted from the thermopiles 17, 18 so that an encoder output similar to that at the mouse moving time is outputted from the mouse to the personal computer. This is the signal component provided by the gravitational acceleration.

In the case of the mouse of the opening type, the signal component according to the acceleration in the moving direction at the operating time of the mouse and the signal component provided by the gravitational acceleration are very small in comparison with the signal component according to the speed in the moving direction. Therefore, the signal component according to the acceleration in the moving direction and the signal component provided b y the gravitational acceleration can be neglected. Accordingly, in the case of the mouse of the opening type, as described in connection with the explanations of FIGS. 10 to 15, the output signal from the flow sensor can be considered as the signal according to the speed in the moving direction of the mouse, and it is not necessary to practically consider the influence of the acceleration.

However, in the case of the mouse of the closing type, the sensitivity with respect to the moving speed is low in comparison with the moving acceleration. Accordingly, the difference signal outputted from the flow sensors 17, 18 is treated as a signal showing the moving acceleration of the mouse as mentioned above. Further, differing from the case of the operation on the operating face, there is a high fear that the mouse is inclined when the closing type mouse is operated in the air. Accordingly, no signal component provided by the gravitational acceleration can be neglected and it is necessary to correct this signal component. There is the following method as a correcting method of this gravitational acceleration.

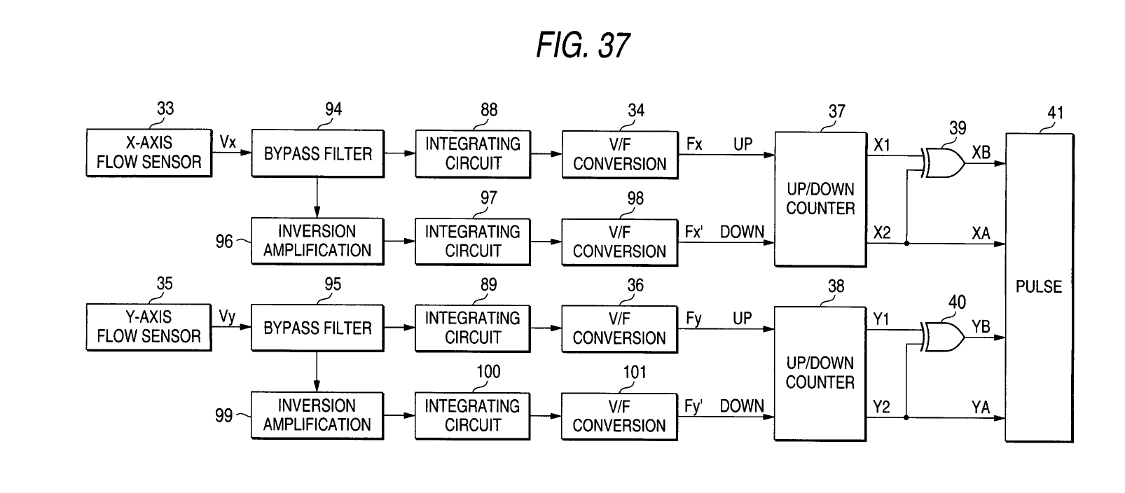

(Thirteenth embodiment mode) FIG. 37 shows a signal processing circuit used in the closing type mouse in accordance with still another embodiment mode of the present invention. In this signal processing circuit, the output Vx (acceleration signal) of the X-axis flow sensor 33 is transmitted through a high-pass filter 94 so that a direct current component and a low frequency component in its vicinity are removed and are then integrated by the integrating circuit 88 and are converted to a speed signal. An output voltage from the integrating circuit 88 is converted to a frequency signal Fx by the V/F converting circuit 34, and the signal of a frequency according to the moving speed in the positive direction of the mouse is outputted to the up/down counter 37. On the other hand, an output signal from the high-pass filter 94 is inverted in positive and negative by an inversion amplifying circuit 96 (including 1 in amplification factor), and is then integrated by an integrating circuit 97 and is converted to a speed signal. An output voltage from the integrating circuit 88 is converted to a frequency signal by a V/F converting circuit 98 so that a signal Fx′ of a frequency according to the moving speed in the negative direction of the mouse is outputted to the up/down counter 37. Here, when the moving speed of the mouse is zero, the output voltages from the integrating circuits 88, 97 become zero. No V/F converting circuits 34, 98 output a frequency modulating signal when the input voltage is zero and negative. The up/down counter 37 is counted up every peak of the frequency modulating signal Fx outputted from the V/F converting circuit 34, and is counted down every peak of the frequency modulating signal Fx′ outputted from the V/F converting circuit 98.

Accordingly, when the mouse is moved in the +X direction, a signal showing the moving speed of the mouse as shown in e.g. FIG. 34(c) is outputted from the integrating circuit 88, and the signal of a frequency proportional to the moving speed is outputted from the V/F converting circuit 34, and the up/down counter 37 is counted up every peak of this signal. On the other hand, since the output from the high-pass filter 94 is inverted in positive and negative by the inversion amplifying circuit 96, the output from the integrating circuit 97 becomes a signal provided by inverting the signal of FIG. 34(c) on the negative side with respect to the time axis. No signal is outputted from the V/F converting circuit 98. Accordingly, the up/down counter 37 is only counted up by the output from the V/F converting circuit 34.

In contrast to this, when the mouse is moved in the −X direction, a signal provided by inverting the signal of e.g., FIG. 34(c) with respect to the time axis and showing the moving speed of the mouse is outputted from the integrating circuit 88. No signal is outputted from the V/F converting circuit 34. On the other hand, since the output from the high-pass filter 94 is inverted in positive and negative by the inversion amplifying circuit 96, the output from the integrating circuit 97 becomes a signal as shown in FIG. 34(c). The signal of a frequency proportional to the moving speed is outputted from the V/F converting circuit 98, and the up/down counter 37 is counted down every peak of this signal. Accordingly, the up/down counter 37 is only counted up by the output from the V/F converting circuit 98.

Similarly, with respect to the output Vy (acceleration signal) of the Y-axis flow sensor 35, a direct current component and a low frequency component in its vicinity are removed through the high-pass filter 95, and are then integrated by the integrating circuit 89, and are converted to a speed signal. The speed signal is then inputted to the V/F converting circuit 34, and is converted and an output signal Fy from the V/F converting circuit 34 is outputted to an up-operating side port of the up/down counter 38. Further, the output signal from the high-pass filter 95 is inverted in positive and negative by the inversion amplifying circuit 99 (including 1 in amplification factor), and is then integrated by an integrating circuit 100, and is converted to a speed signal. An output voltage from the integrating circuit 100 is converted to a frequency signal by a V/F converting circuit 101. A signal Fy′ of a frequency according to the moving speed of the mouse in its negative direction is outputted to a down-operating side port of the up/down counter 38. A portion for treating the mouse movement in this Y-axis direction performs the same operation as the above portion for treating the mouse movement in the X-axis direction.

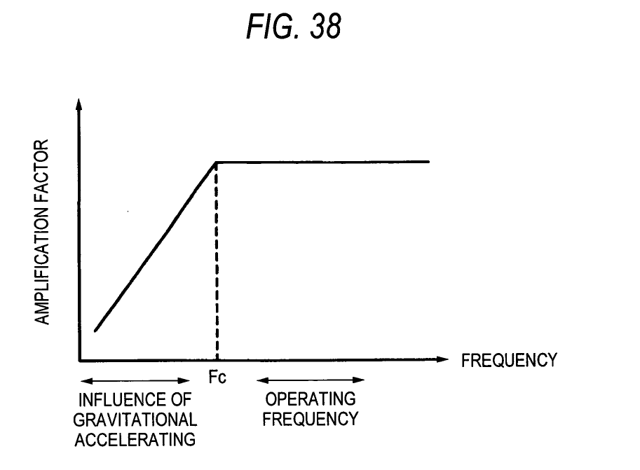

For example, the output from the flow sensor 6 provided by the acceleration at the mouse operating time has a vibrational waveform as shown in FIG. 34(b). In contrast to this, the output from the flow sensor 6 provided by the gravitational acceleration is approximately a direct current component (or a very low frequency component). Therefore, if the frequency characteristics of the high-pass filters 94, 95 connected to the outputs of the X-axis flow sensor 33 and the Y-axis flow sensor 35 are set such that a cutoff frequency Fc is higher than the frequency area of an output component provided by the gravitational acceleration and is lower than the frequency area of an acceleration component provided by the mouse operation as shown in FIG. 38, only the influence due to the gravitational acceleration can be removed so that accuracy of the mouse can be improved.

Further, in the signal processing circuit constructed as shown in FIG. 33, the signal of a frequency of about 1 kHz is outputted from each of the V/F converting circuits 32, 34, 36 even when no mouse is moved. However, in the signal processing circuit constructed as shown in FIG. 37, no signal is outputted (zero in frequency) from each of the V/F converting circuits 34, 36, 98, 101 when no mouse is moved. Accordingly, even when the mouse is operated, it is possible to reduce the frequencies of the signals outputted from the V/F converting circuits 34, 36, 98, 101 to the up/down counters 37, 38 so that the operations of the up/down counters 37, 38 can be stabilized.

In the opening type mouse, the influence of the gravitational acceleration is basically small. However, if the method for removing the influence of the gravitational acceleration by the high-pass filter is also adopted in the opening type mouse, accuracy of the opening type mouse can be further improved.

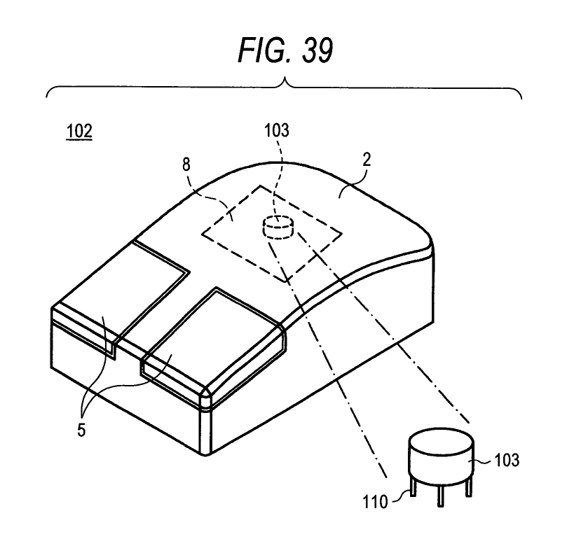

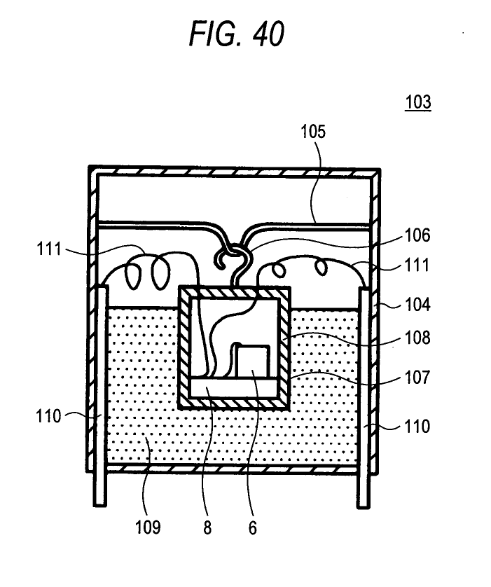

(Fifteenth embodiment mode) FIG. 39 is a perspective view showing a closing type mouse 102 in accordance with still another embodiment mode of the present invention. In this mouse 102, a movement detecting unit 103 of a closing type is stored into the mouse case 2. In the movement detecting unit 103, as shown in FIG. 40, a support beam 105 is laid within a hollow case 104, and a flow sensor unit 107 is swingably suspended by a hook 106 in a bent portion of the support beam 105. In the flow sensor unit 107, the circuit substrate 8 mounting the flow sensor 6 thereto is fixed into a unit case 108. When the flow sensor unit 107 is swingably suspended by the hook 106 arranged on the upper face of the unit case 108, the position of the center of gravity of the flow sensor unit 107 is adjusted such that a perpendicular detecting direction (Z-axis direction) of the flow sensor 6 is parallel to a gravitational acceleration direction in a stable state. Further, an oil damper is formed by storing an oil 109 of a suitable viscosity into the case 104, and the flow sensor unit 107 is dipped into the oil 109. Further, an electrode terminal 110 is buried into the case 104 of the movement detecting unit 103 so as to be extended through the interior and the exterior. The flow sensor 6 or the circuit substrate 8 and the electrode terminal 110 are connected to each other by a flexible lead wire 111. Accordingly, the output of the flow sensor 6 is taken out to the electrode terminal 110.

In accordance with this mouse 102, even when the mouse 102 operated in the air is inclined, the flow sensor unit 107 within the movement detecting unit 103 is moved against the resistance of the oil 109 and is held in a horizontal posture. Therefore, the flow sensor 6 is maintained in a state in which no flow sensor 6 is influenced by the gravitational acceleration at any time. Accordingly, the output component provided by the gravitational acceleration is zero at any time, and accuracy of the mouse 102 is improved.

In the opening type mouse, the influence of the gravitational acceleration is basically small. However, if the movement detecting unit of such a structure is also used in the opening type mouse, the accuracy of the opening type mouse can be further improved.

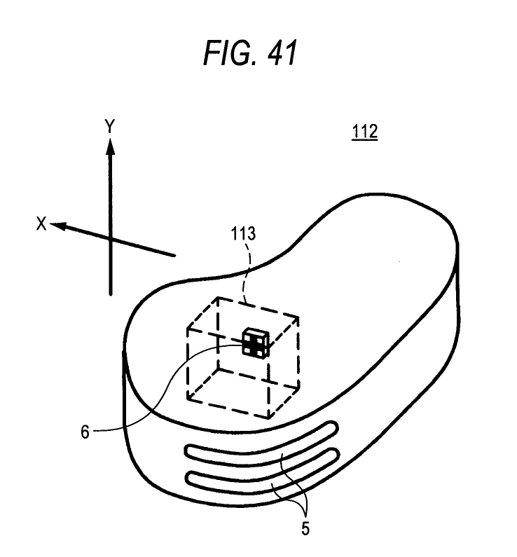

(Sixteenth embodiment mode) FIG. 41 is a perspective view showing a closing type mouse 112 able to be operated in the air in accordance with still another embodiment mode of the present invention. This mouse is transversally gripped by the palm of a hand, and a click button 5 arranged on a side face is pushed by the index finger and the middle finger. A movement detecting unit 113 of a closing type is stored into the mouse 112. The flow sensor 6 is arranged within this movement detecting unit 113 so as to detect the movements in the vertical direction and the leftward-rightward direction. The mouse 112 has sensitivity in the leftward-rightward direction (X-axis direction) and the vertical direction (Z-axis direction), but has no sensitivity in the forward-backward direction (Y-axis direction). For example, such a mouse 112 can be used to operate a pointer projected onto a projector, and the pointer on the screen can be moved upward, downward, leftward and rightward by moving the mouse upward, downward, leftward and rightward.

Since such a mouse 113 has sensitivity in the vertical direction, there is a fear that the influence of the gravitational acceleration becomes notable. Accordingly, as mentioned above, it is more important to remove the influence of the gravitational acceleration by using a high-pass filter, a flow sensor unit, etc. vertically suspended.

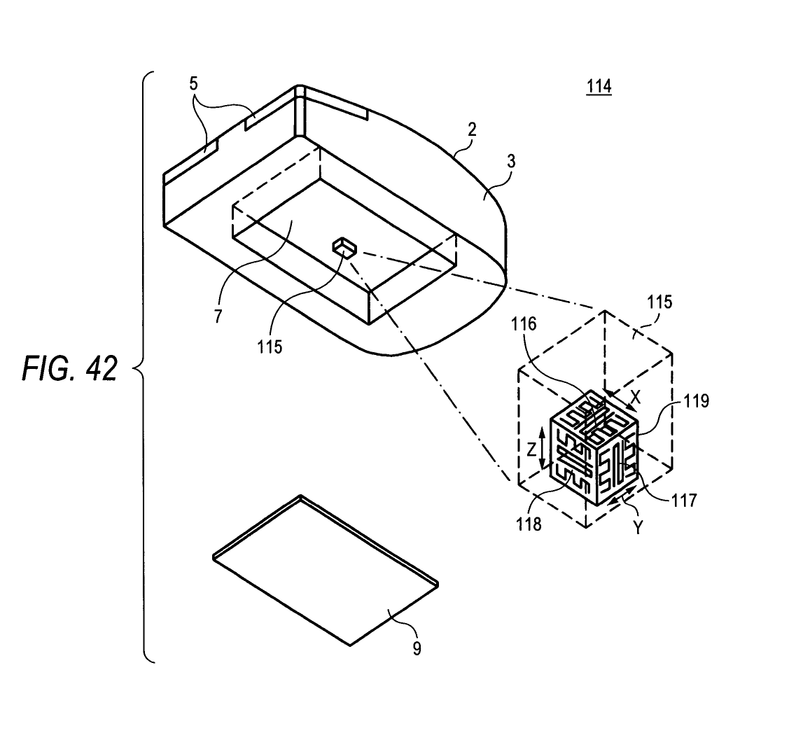

(Seventeenth embodiment mode) A two-dimensional mouse able to be operated in the air has been explained so far. However, this mouse can be also extended to a three-dimensional mouse since the mouse can be operated in the air. FIG. 42 shows still another embodiment mode of the present invention in which the movement in the three-dimensional direction can be detected. In this mouse 114, a movement detecting unit 115 able to detect the flow of a gas in the three-dimensional direction is attached into the concave portion 7 of the mouse case 2. A structure for sticking a flow sensor 116 for detecting the movement in the X-axis direction, a flow sensor 117 for detecting the movement in the Y-axis direction, and a flow sensor 118 for detecting the movement in the Z-axis direction to the respective faces of a block 119 formed in a cubic body shape is sealed within the movement detecting unit 115.

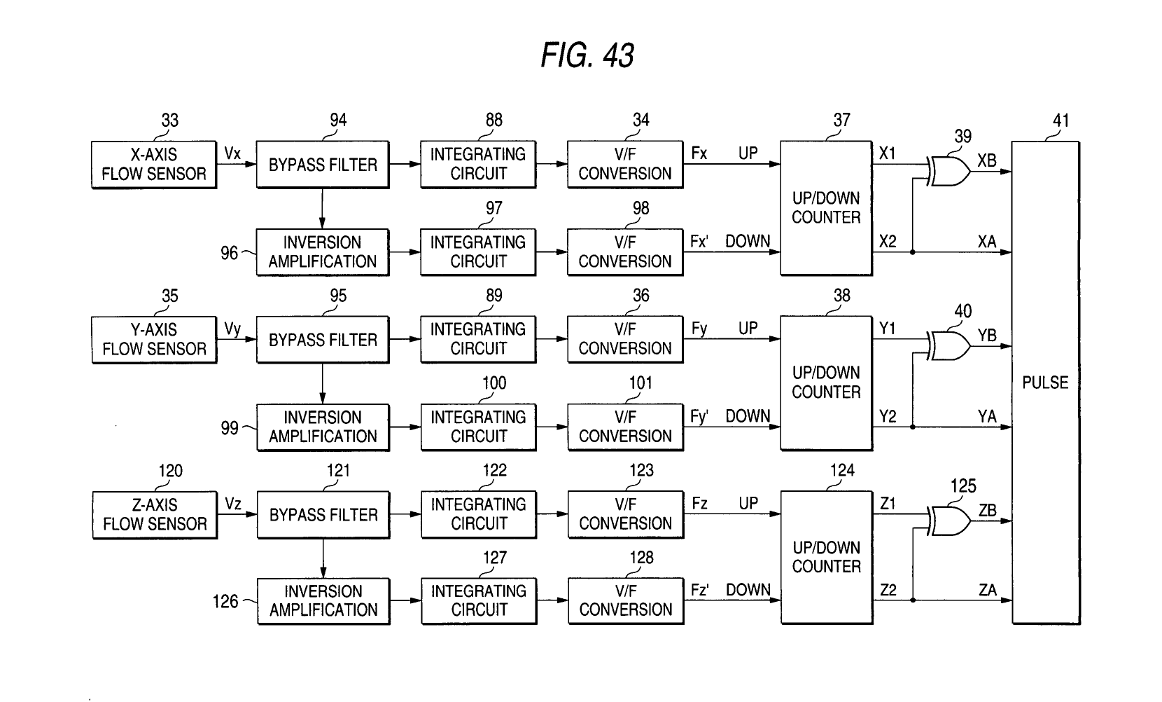

FIG. 43 is a circuit diagram showing a signal processing circuit of this mouse 114. In this signal processing circuit, the processing circuit of a Z-axis component is added with the signal processing circuit of FIG. 37 as a base. Although the details are omitted, the movement in the Z-axis direction is detected by a Z-axis flow sensor 120 in accordance with this signal processing circuit. A direct current component is removed from an output Vz outputted from the Z-axis flow sensor 120 by a high-pass filter 121. Thereafter, this output is converted from an acceleration signal to a speed signal by an integrating circuit 122. Further, the speed signal is converted to a frequency signal Fz by a V/F converting circuit 123. On the other hand, an output signal from the high-pass filter 121 is inverted in positive and negative by an inversion amplifying circuit 126 (including 1 in amplification factor), and is then integrated by an integrating circuit 127, and is converted to a speed signal. An output voltage from the integrating circuit 127 is converted to a frequency signal Fz′ by a V/F converting circuit 128. An up/down counter is counted up by the output Fz from the V/F converting circuit 123, and is counted down by the output Fz′ from the V/F converting circuit 128. A count value outputted from the up/down counter 124 is converted to the Z-axis component of an encoder output by a gate 125.

Here, the high-pass filter is used to remove the influence of the gravitational acceleration, but another method may be naturally used.

In the closing type mouse able to be operated in the air, the influence of the gravitational acceleration is removed. However, when the mouse is moved with acceleration, an acceleration component sensed by the mouse is reduced as the inclination of the mouse is increased. Accordingly, if the influence of the gravitational acceleration is removed, the sensitivity of the mouse can be reduced by slantingly moving the mouse so that the sensitivity of the mouse can be adjusted by the inclination of the mouse.

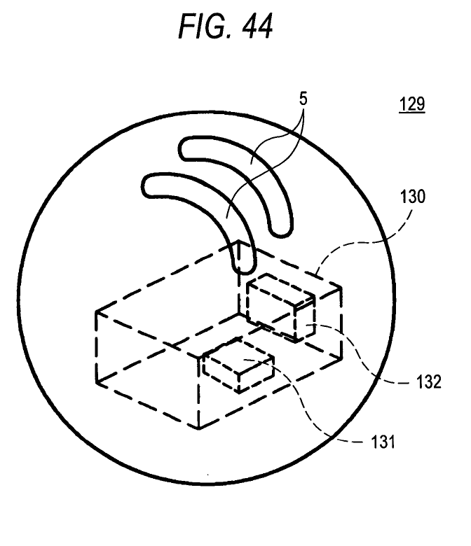

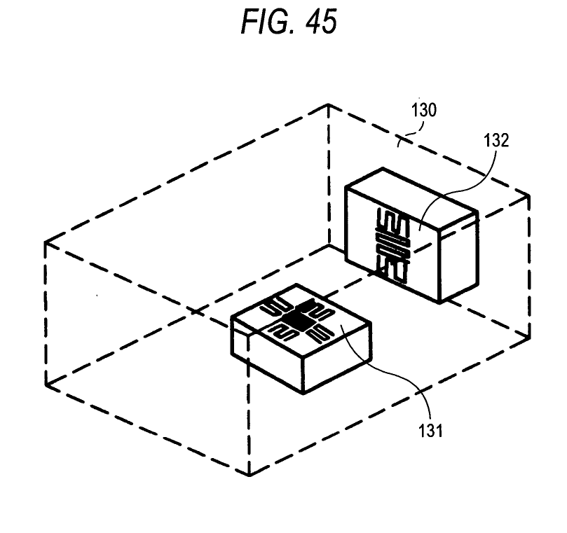

(Eighteenth embodiment mode) FIG. 44 is a perspective view showing an embodiment mode showing a different three-dimensional mouse 129. The external appearance of this mouse 129 has a ball shape, and a click button 5 is arranged on the mouse surface. FIG. 45 is a perspective view showing a movement detecting unit 130 within the mouse 129. A flow sensor 131 (see FIG. 4) able to detect two axis directions and a flow sensor 132 able to detect one axis direction are sealed within the movement detecting unit 130. The moving direction of the mouse 129 can be detected in three dimensions in the directions of the X-axis, the Y-axis and the Z-axis in total.

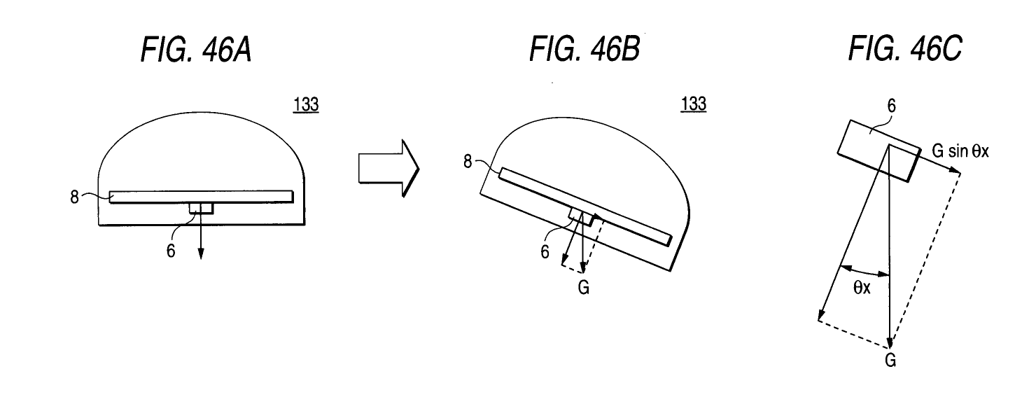

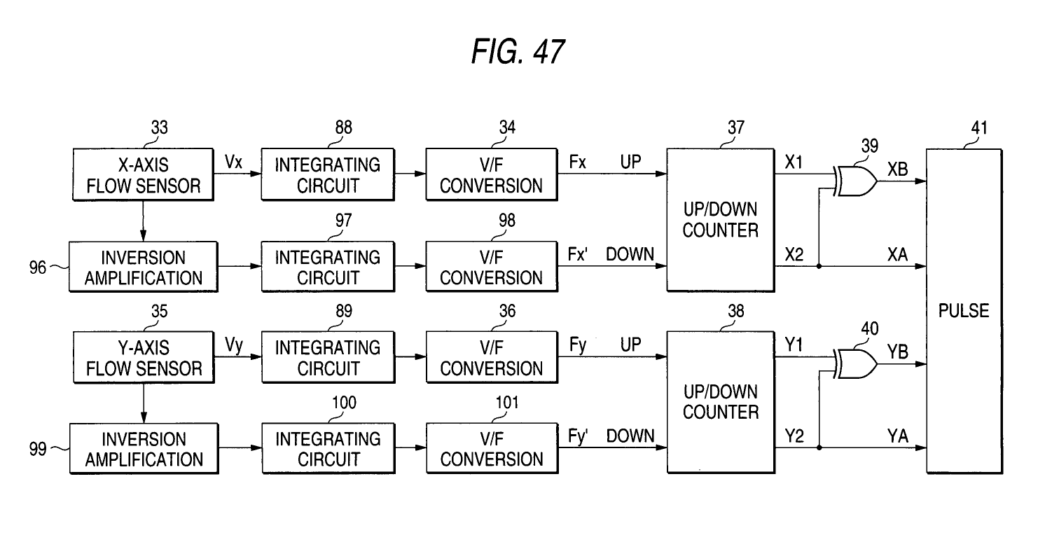

(Nineteenth embodiment mode) FIGS. 46(a), 46(b) and 46(c) are explanatory views of a mouse 133 in accordance with still another embodiment mode of the present invention. The influence of the gravitational acceleration at the inclining time of the mouse 133 is removed in the mouse 133 explained so far. However, this phenomenon may be positively utilized, and the pointer on the screen of the personal computer, etc. may be also moved by the inclination of the mouse 133. FIG. 47 is a circuit diagram showing a signal processing circuit of this mouse 133. The high-pass filters 94, 95 are removed in comparison with the signal processing circuit of FIG. 37. Further, no movement detecting unit 103 of the structure constructed as shown in FIG. 40 is also used. Therefore, when the mouse is inclined by θx leftward and rightward as shown in FIG. 46(b) from a horizontal posture as shown in FIG. 46(a), a component force Gsinθx of the gravitational acceleration G is generated in parallel with the surface of the flow sensor 6 in the X-axis direction. Accordingly, as shown in FIG. 46(c), a gas heated by the heater 16 is flowed in the X-axis direction, and the same encoder output as the movement of the mouse 133 in the X-axis direction is outputted from the mouse 133. Similarly, when the mouse 133 is inclined forward and backward, the same encoder output as the movement of the mouse 133 in the Y-axis direction is outputted from the mouse 133.

In such a mouse, a low pass filter may be inserted between the X-axis flow sensor and the integrating circuit so as not to detect the movements of the mouse in the X-axis direction and the Y-axis direction, and a low pass filter may be also inserted between the Y-axis flow sensor and the integrating circuit.

Such a mouse is not limited to the so-called mouse type. In the mouse of a ball type as shown in FIG. 44, the pointer can be operated by rotating this mouse. Further, in a pointing device having a track ball, a structure and a circuit for detecting the rotation of the track ball can be assembled into the track ball itself.

(Twentieth embodiment mode) The closing type mouse has been explained so far as the mouse able to be operated in the air, but the opening type mouse can be also used in the air. However, in the opening type mouse, there is a fear that a disturbance such as a wind, etc. is detected in error as the movement of the mouse as mentioned above. Accordingly, in the opening type mouse operated in the air, it is necessary to set the sensitivity of the flow sensor to be low in comparison with the opening type mouse used on the operating face.

Further, in the opening type mouse, an acceleration signal component at the mouse moving time and a signal component provided by the gravitational acceleration are small in comparison with a speed signal component at the mouse moving time even when the opening type mouse is operated in the air. Therefore, differing from the closing type mouse, the influence due to the acceleration is small. Accordingly, the influence of the gravitational acceleration is not necessarily removed by using the high-pass filter and the movement detecting unit of the structure as shown in FIG. 40 as in the closing type mouse. However, if the influence of the gravitational acceleration is also removed by such a means in the opening type mouse, the mouse can be more precisely set.

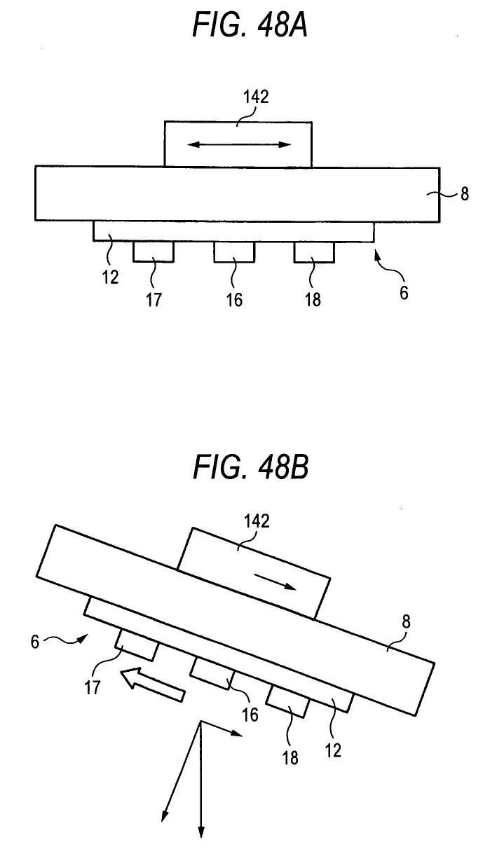

Further, in the case of the mouse of the opening type, as shown in FIG. 48(a), an acceleration sensor 142 may be also arranged in the circuit substrate 8 of the flow sensor 6 so as to detect the acceleration in the direction parallel to the circuit substrate 8. If such an acceleration sensor 142 is arranged, the acceleration of the mouse can be detected by the acceleration sensor 142 when the mouse is operated and moved. Further, when the mouse is inclined as shown in FIG. 48(b), it is also possible to detect a component in the direction parallel to the circuit substrate 8 among the gravitational acceleration applied to the flow sensor 6. Accordingly, the influences of the acceleration due to the movement of the mouse and the gravitational acceleration can be removed and only a signal showing the moving speed of the mouse can be utilized by subtracting the output of the acceleration sensor 142 provided by the acceleration at the moving time and the component Gsinθ of the gravitational acceleration G provided by inclining the flow sensor 6 by θ from the output of the flow sensor 6. Thus, accuracy of the mouse can be improved.

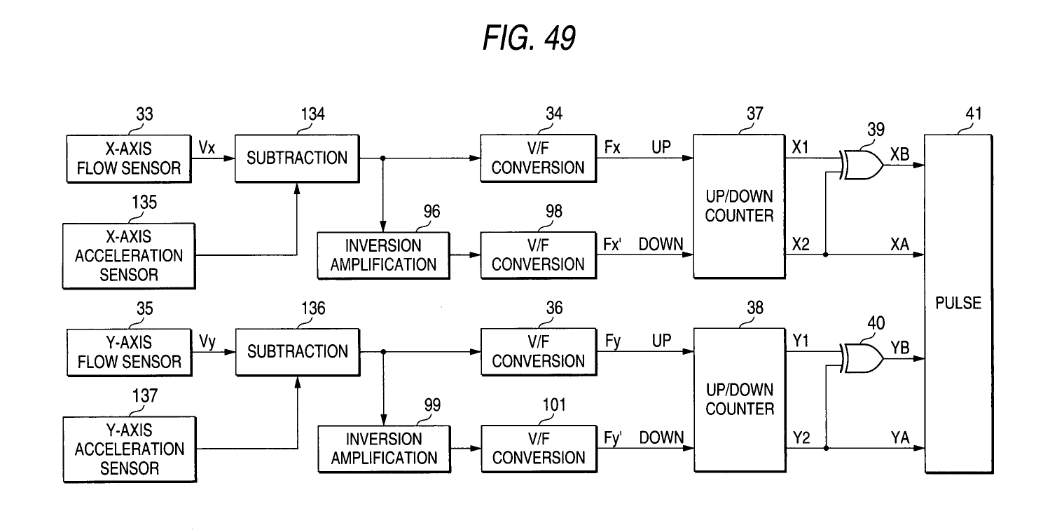

FIG. 49 shows a signal processing circuit of the mouse having the acceleration sensor 142 and the flow sensor 6 as mentioned above. Here, an X-axis acceleration sensor 135 shows a function for detecting the acceleration in the X-axis direction in the acceleration sensor 142. A Y-axis acceleration sensor 137 shows a function for detecting the acceleration in the Y-axis direction in the acceleration sensor 142. Subtracting circuits 134, 136 subtract acceleration signals detected by the acceleration sensors 135, 137 from signals outputted from the flow sensors 33, 35. The outputs of the acceleration sensors 135, 137 are amplified or damped and are then subtracted such that the strengths of the acceleration component and the gravitational acceleration component included in the signals outputted from the flow sensors 33, 35 and the strengths of the signals outputted from the acceleration sensors 135, 137 are equal to each other.

In the case of the mouse of the closing type, since the signal outputted from the flow sensor is the acceleration, the acceleration component, etc. cannot be canceled by the output of the acceleration sensor. However, in the case of the mouse of the opening type, the signal outputted from the flow sensor is the speed. Accordingly, accuracy of the mouse can be improved by canceling the acceleration component, etc. by the output of the acceleration sensor by such a method.

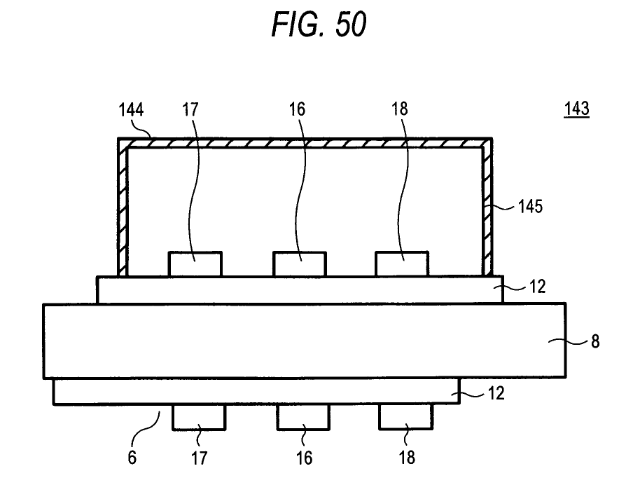

As shown in FIG. 50, a flow sensor 144 of a closing type may be also used as the acceleration sensor. In the flow sensor 144 of the closing type, a signal due to the speed at the moving time is weak, and a signal due to the acceleration at the moving time and a signal due to the gravitational acceleration are predominant. Accordingly, only the signal due to the speed at the moving time can be taken out by subtracting the output of the flow sensor 144 of the closing type from the output of the flow sensor 6 of the opening type. Thus, the accuracy of the mouse using the flow sensor 6 of the opening type can be further improved.

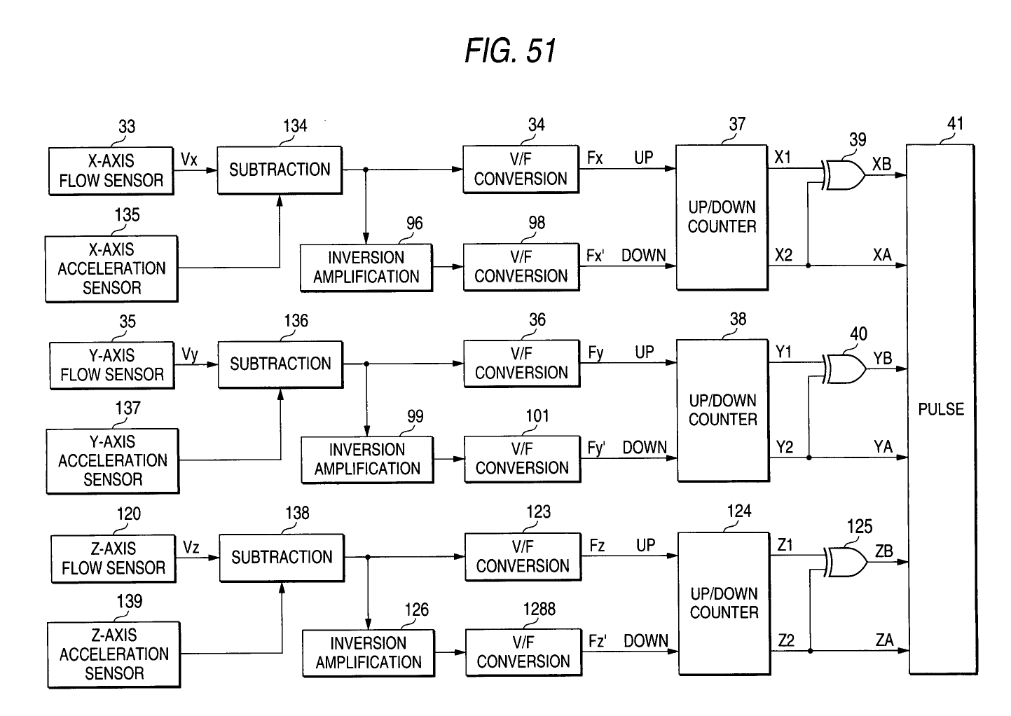

(Twenty-first embodiment mode) FIG. 51 is a circuit diagram showing a signal processing circuit used in the mouse of the opening type able to be three-dimensionally operated in accordance with still another embodiment mode of the present invention. This signal processing circuit has an acceleration sensor 139 for detecting the acceleration in the Z-axis direction. A signal due to the acceleration in the Z-axis direction detected by the Z-axis acceleration sensor 139 is subtracted from a signal Vz outputted from the Z-axis flow sensor 120 by a subtracting circuit 138, and the subtracted result is outputted to a V/F converting circuit 123 and an inversion amplifying circuit 126.

Accordingly, in this mouse, the influences of the acceleration and the gravitational acceleration at the moving time are removed in the three axis directions of the X-axis direction, the Y-axis direction and the Z-axis direction so that a three-dimensional mouse of high accuracy is realized.

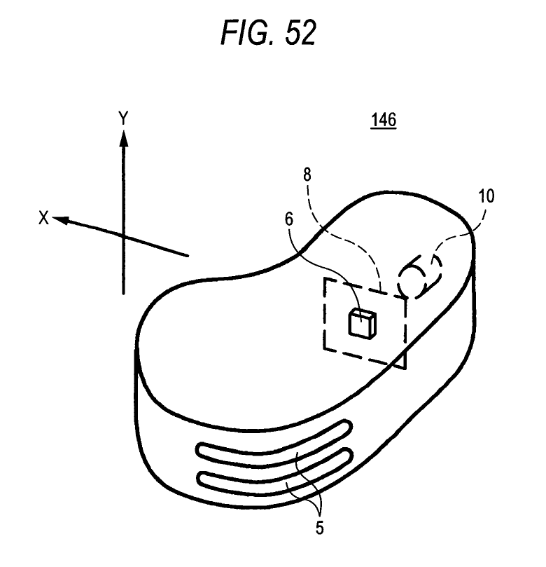

(Twenty-second embodiment mode) FIG. 52 shows a mouse 146 in accordance with still another embodiment mode of the present invention. Similar to the mouse shown in FIG. 41, the mouse of a type transversally gripped and moved upward, downward, leftward and rightward is realized by the opening type. Since this mouse is of the opening type, an opening 10 is formed so as to be opposed to the flow sensor 6 mounted to the circuit substrate 8.

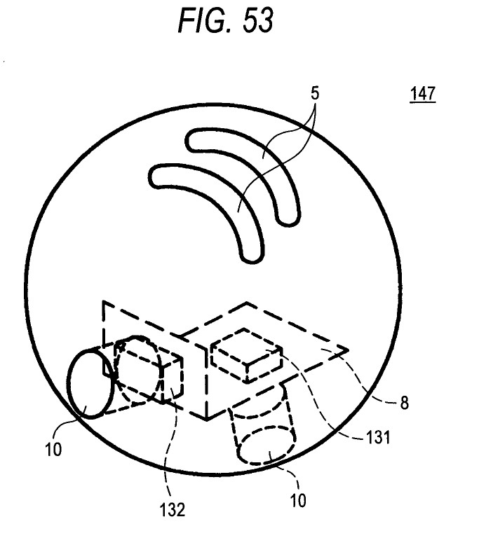

(Twenty-third embodiment mode) FIG. 53 shows a mouse 147 in accordance with still another embodiment mode of the present invention, and the mouse of a spherical shape similar to that shown in FIG. 44 is realized by the opening type. Since this mouse is of the opening type, an opening 10 is formed so as to be opposed to each of flow sensors 131, 132 mounted to the circuit substrate 8.

(Twenty-fourth embodiment mode) Each of the above closing type mice can be operated by moving the mouse in the air (e.g., as if the mouse is moved on the operating face). This could not be performed in the conventional ball type mouse and optical type mouse. However, when the mouse reaches the end of an operating range (for example, a hand gripping the mouse is completely extended), the mouse can be returned into the operating range by floating the mouse from the operating face in the case of the mouse used on the operating face. In contrast to this, in the case of the mouse operated in the air, when the mouse is returned into the operating range, its movement is detected by the flow sensor 6 so that there is a fear that the pointer on the screen of the personal computer is also returned.

There is a method for moving and returning the mouse at a constant speed so as not to move the pointer on the screen of the personal computer even when the mouse is returned into the operating range. However, this method is not necessarily satisfactory in use. Therefore, there is a method explained below as a method set such that no movement of the mouse is detected when the mouse is returned into the operating range.

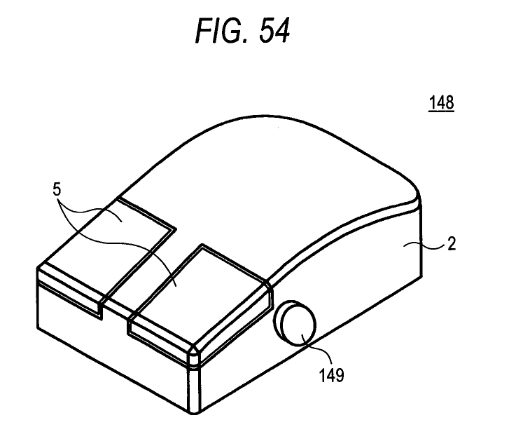

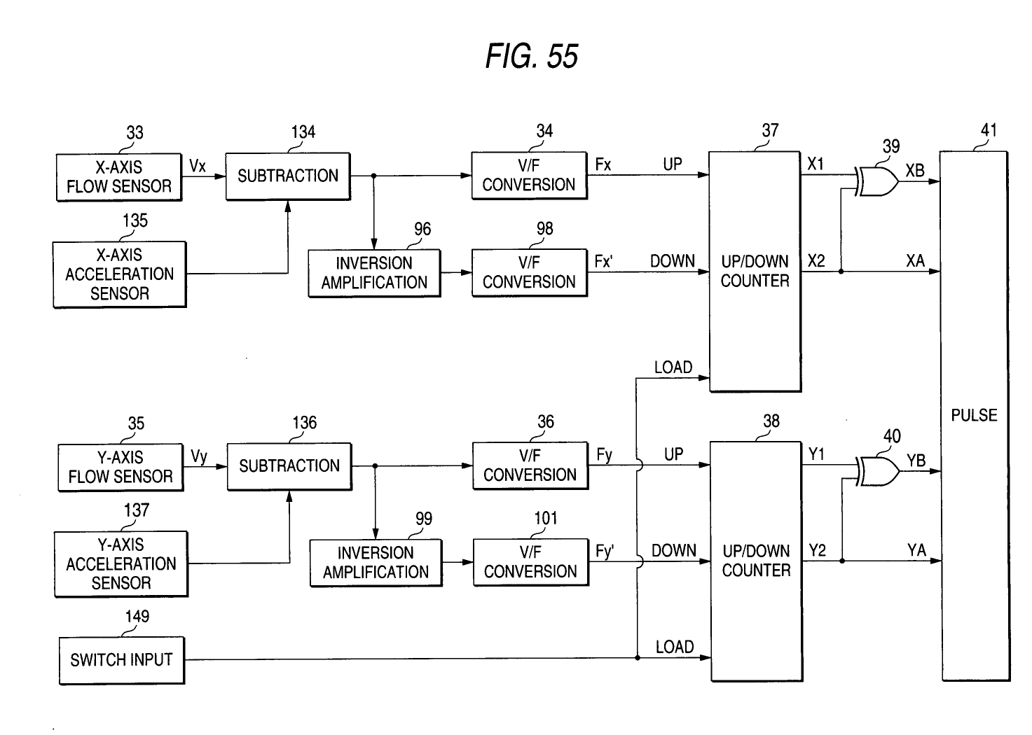

FIG. 54 is a perspective view of this mouse 148. For example, a change-over switch 149 is arranged in a thumb position on a side face of this mouse 148. As shown in FIG. 55, this change-over switch 149 is connected to up/down counters 37, 38. The up/down counters 37, 38 can change count outputs according to signals from V/F converting circuits 34, 98, 36, 101 only when the change-over switch 149 is pushed and turned on. When the change-over switch 149 is turned off by separating the thumb from the change-over switch 149, the up/down counters 37, 38 attain a lock state and do not change the count outputs.

Accordingly, when the mouse 148 is operated, this operation is performed in the state in which the change-over switch 149 is pushed and turned on by the thumb. When only the mouse 148 is returned, the mouse 148 is moved in the state in which the change-over switch 149 is turned off by separating the thumb from the change-over switch 149. In accordance with such a construction, even when the mouse 148 is operated in the air, the mouse 148 can be used in a using method similar to that in the operating case on the operating face.

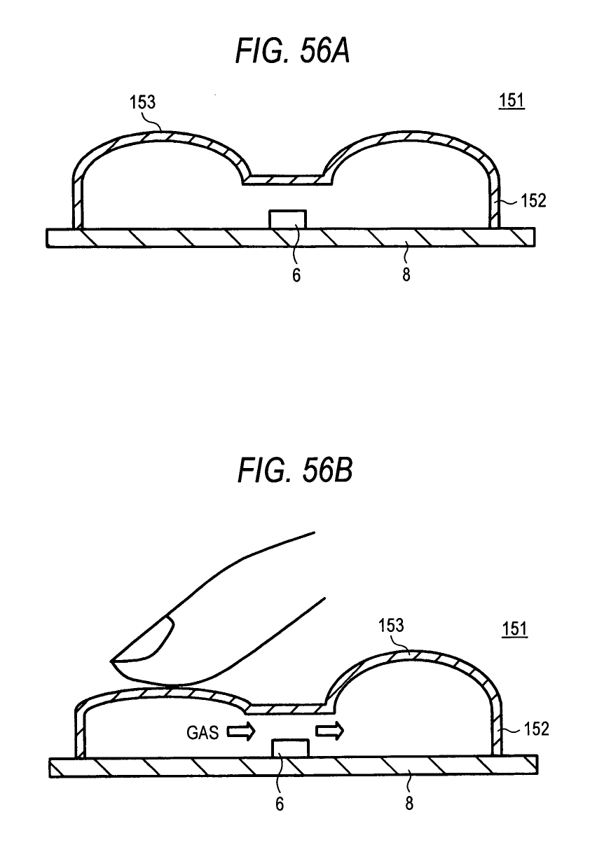

(Twenty-fifth embodiment mode) Pointing devices of various modes will next be explained. FIG. 56(a) shows a pointing device 151 of an entire azimuth switch type. In this pointing device 151, a flow sensor 6 (see FIG. 4) of a two-axis type is arranged in the center of a circuit substrate 8 on its upper face. The circuit substrate 8 is covered with a touch cover 152. The flow sensor 6 is sealed in the central portion of the interior of the touch cover 152. The touch cover 152 is recessed in its central portion opposed to the flow sensor 6, and is arranged in proximity to the flow sensor 6. The touch cover 152 is swollen in an annular shape in its circumference. The touch cover 152 may be formed by an elastic material such as rubber, etc, or may also have an expansion structure such as bellows, etc.

In this pointing device 151, as shown in FIG. 56(b), when the annular portion 153 of the touch cover 152 is pushed, a gas is flowed from the position pushed by a finger to the opposite side. The pushed position and the operating speed are discriminated by detecting this gas flow by the flow sensor 6.

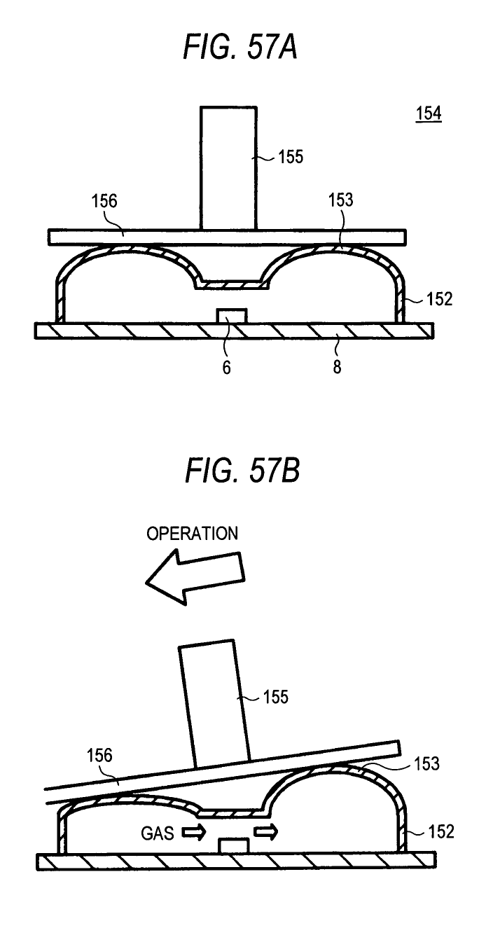

(Twenty-sixth embodiment mode) As shown in FIG. 57(a), the pointing device can be used as a joystick 154 by arranging a disk 156 having a stick 155 on the annular portion 153 of the touch cover 152. In this joystick 154, the stick 155 is gripped and inclined as shown in FIG. 57(b) so that the touch cover 152 is pushed and a gas flow is internally generated within on the inclining side. The inclining direction of the stick 155 is discriminated by detecting this gas flow by the flow sensor 6, and an encoder output is outputted.

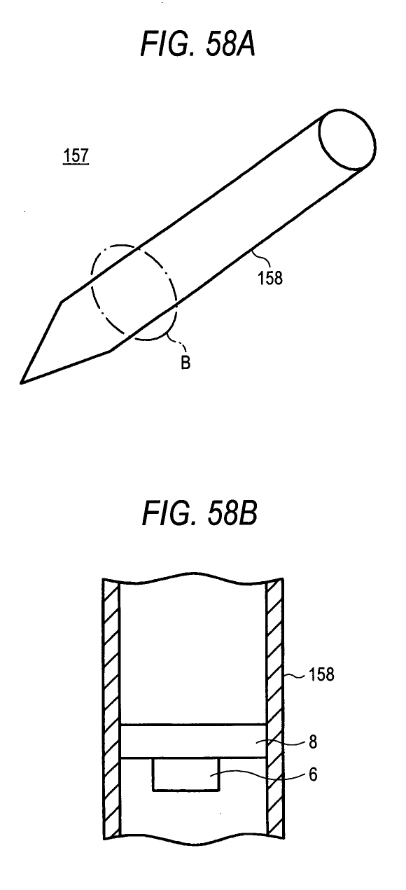

(Twenty-seventh embodiment mode) FIG. 58(a) is a perspective view of the pointing device 157 of a pen type. FIG. 58(b) is an enlarged sectional view of a B-portion of FIG. 58(a). In this pointing device 157, the flow sensor 6 mounted to the circuit substrate 8 is stored into a shaft portion 158. Such a pointing device 157 of the pen type can be used as a pen plotter. This pointing device 157 can be also used as a pointer for directing the screen projected by a projector and moving the pointer on the screen, and a pen type pointing device for moving the pointer on the screen by tracing an original.

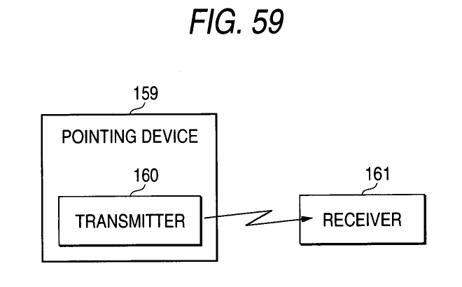

(Twenty-eighth embodiment mode) FIG. 59 shows the pointing device of a wireless type in which a transmitter 160 is added to the pointing device 159, and a signal is sent to a receiver 161 connected to a personal computer, etc. by a radio wave.

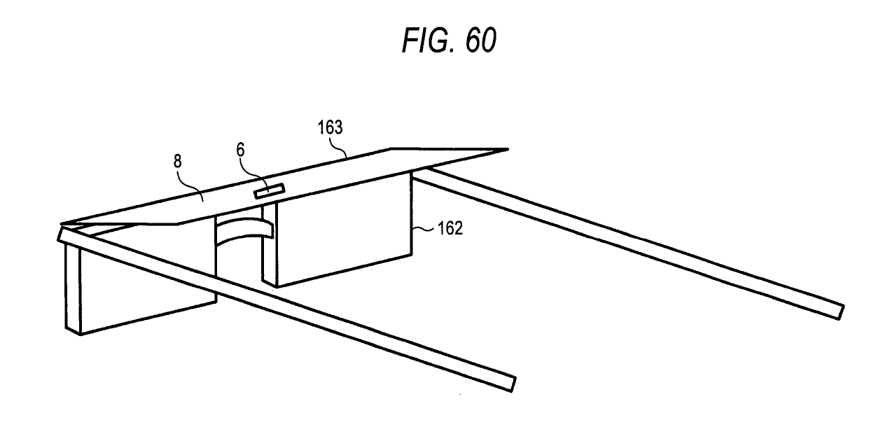

(Twenty-ninth embodiment mode) FIG. 60 shows a head mount display 162 mounting the pointing device 163 of an operating type in the air in the present invention thereto. This head mount display 162 is mounted to the head and the head is moved, and the body is moved so that a signal according to the movement can be transmitted from the pointing device 163 to a game machine, a personal computer, etc.

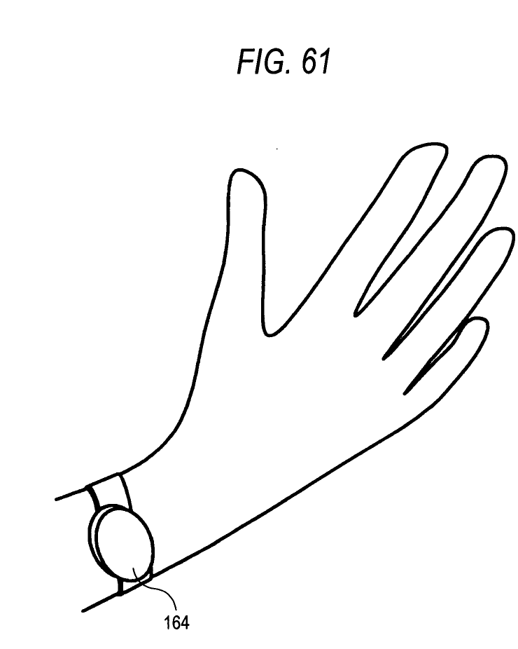

(Thirtieth embodiment mode) FIG. 61 shows the pointing device 164 of a wristwatch type. If this pointing device 164 is attached to an arm, a signal according to the movement of the arm can be outputted from the pointing device 164.

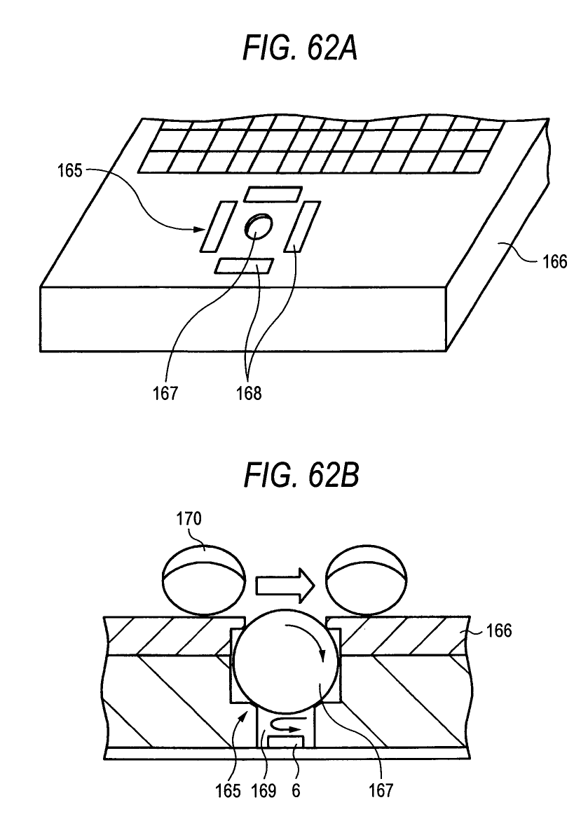

(Thirty-first embodiment mode) FIG. 62(a) shows a track ball 165 mounted to a personal computer 166 of a notebook type in which a click button 168 is arranged around a ball 167. In this track ball 165, as shown in FIG. 62(b), a space 169 is formed below the ball 167 rotatably held, and the flow sensor 6 of a two-axis type is arranged in this space 169. When the ball 167 is rotated by sliding a finger 170 on the surface of the ball 167, an air flow is caused in the space between the ball 167 and the flow sensor 6. The rotating direction and the rotating angle of the ball 167 can be detected by detecting the flow velocity of the air by the flow sensor 6.

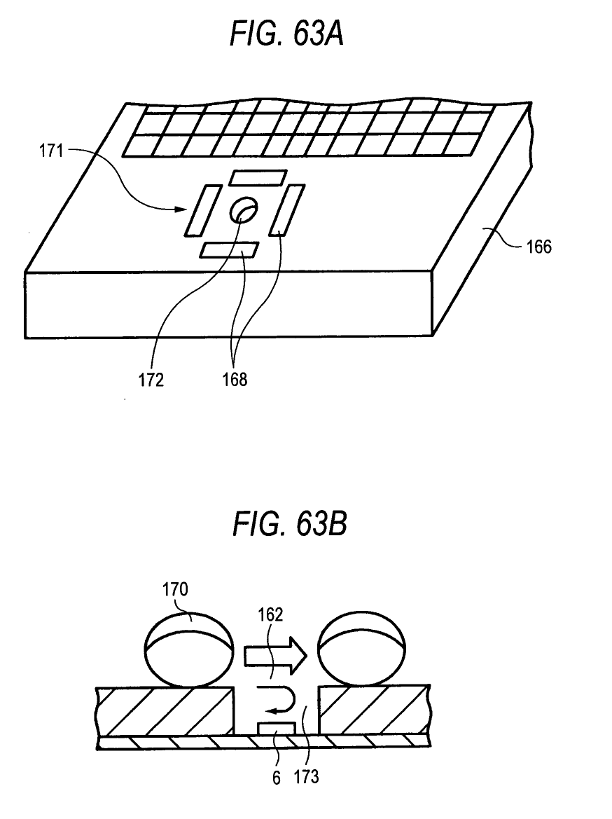

(Thirty-second embodiment mode) FIG. 63(a) shows a pointing device 171 mounted to a personal computer 166 of a notebook type. In this pointing device 171, an opening 172 is formed in a position surrounded by a click button 168. The flow sensor 6 of a two-axis type is arranged in a space 173 below this opening 172. In this pointing device 171, as shown in FIG. 63(b), when a finger 170 is slid so as to pass through the opening 172 thereon, an air flow is caused in the space 173. The passing direction and the passing speed of the finger 170 can be detected by detecting the flow velocity of the air by the flow sensor 6.

### INDUSTRIAL APPLICABILITY

The pointing device of the present invention is used as a peripheral device of the computer. For example, the pointing device is used to move the pointer of the display screen in the personal computer, and operate a button and an icon on the screen, and select various kinds of objects.

1. A pointing device for outputting a signal showing a movement at an operating time, and comprising:
a flow sensor for detecting the velocity and/or acceleration of a gas flow;
and means for outputting the signal showing the movement at the operating time on the basis of the relative movement of the gas detected by said flow sensor.

2. A pointing device according to claim 1, wherein an opening opposed to the flow sensor is formed on the bottom face of a case for storing said flow sensor, and an elastic body is attached to the bottom face of the case so as to surround this opening.

3. A pointing device according to claim 1, wherein an opening opposed to the flow sensor is formed on the bottom face of a case for storing said flow sensor, and a shield object is arranged between this opening and the flow sensor, and a vent path is arranged in the shield object in a position dislocated from a detecting face of the flow sensor.

4. A pointing device according to claim 1, wherein an opening opposed to the flow sensor is formed on the bottom face of a case for storing said flow sensor, and a commutator for rectifying the direction of the gas flowed to the flow sensor position is arranged between this opening and the flow sensor.

5. A pointing device according to claim 1, wherein the pointing device further comprises means for detecting that the bottom face of a case for storing said flow sensor is floated.

6. A pointing device according to claim 5, wherein the pointing device further comprises means for stopping the flow of the gas within an area for locating the flow sensor when the bottom face of said case is floated.

7. A pointing device according to claim 1, wherein said flow sensor is arranged on the inner face of a closing case, and the gas passage between the inner face of the closing case opposed to the flow sensor and the flow sensor is narrowed in comparison with the others.

8. A pointing device according to claim 1, wherein said flow sensor is arranged on the inner face of a closing case, and gases of two kinds or more having different specific gravities are sealed within the closing case.

9. A pointing device according to claim 1, wherein the pointing device further comprises means for removing the influence of gravitational acceleration.

10. A pointing device according to claim 9, wherein said means for removing the influence of the gravitational acceleration is a high-pass filter arranged at a stage after the flow sensor.

11. A pointing device according to claim 9, wherein said means for removing the influence of the gravitational acceleration holds the flow sensor in the same posture with respect to a gravitational direction.

12. A pointing device according to claim 9, wherein said means for removing the influence of the gravitational acceleration is an acceleration sensor arranged in the pointing device in which the flow sensor is exposed to the atmosphere.

13. A pointing device according to claim 1, wherein the pointing device has an operating portion able to output an output signal, or set so as not to output the output signal.

14. A pointing device according to claim 1, wherein the signal showing the movement in three-dimensional directions is outputted by the flow sensor.

15. A pointing device for outputting a signal showing an inclination at an operating time, and comprising:
a flow sensor for detecting the velocity and/or acceleration of a gas flow;
and means for outputting the signal showing the inclination at the operating time on the basis of the relative movement of the gas detected by said flow sensor.
